(19) United States
(12) Patent Application Publication
(10) Pub. No.: US 2004/0231667 A1
(43) Pub. Date: Nov. 25, 2004

(54) Medicament dispenser

(76) Inventors: Andrew Paul Horton, Ware (GB); Anthony Patrick Jones, Ware (GB); Mark Gregory Palmer, Ware (GB); Paul Kenneth Rand, Ware (GB)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/479,567

(22) PCT Filed: May 14, 2002
(86) PCT No.: PCT/EP02/05318

(30) Foreign Application Priority Data
Jun. 11, 2001 (GB) 0114175.3

(51) Int. Cl. A62B 7/00

(52) U.S. Cl. 128/202.13

(57) ABSTRACT

There is provided a medicament dispenser comprising a medicament container having a dispensing mechanism; a container seat for receipt of the container; an anchor station; and drive means capable of moving the container seat relative to the anchor station to actuate the dispensing mechanism. The drive means is actuable in response to the application of non-mechanical energy thereto, and gear means are provided to the drive means to gear up the torque provided thereby.

This invention relates to a medicament dispenser including a medicament container having a dispensing mechanism actuable by an actuator. The dispenser is particularly suitable for use as an inhalation device.

It is well known to treat patients with medicaments contained in an aerosol, for example, in the treatment of respiratory disorders. It is also known to use for such treatment, medicaments which are contained in an aerosol and are administered to a patient by means of an inhalation device comprising a tubular housing or sleeve in which the aerosol container is located and an outlet tube leading out of the tubular housing. Such inhalation devices are generally referred to as metered dose inhalers (MDIs). The aerosol containers used in such inhalation devices are designed to deliver a predetermined dose of medicament upon each actuation by means of an outlet valve member at one end which can be opened either by depressing the valve member while the container is held stationary or by depressing the container while the valve member is held stationary. In the use of such devices, the aerosol container is placed in the tubular housing with the outlet valve member of the container communicating via a support with the outlet tube, for example a nozzle or mouthpiece. When used for dispensing medicaments, for example in bronchodilation therapy, the patient then holds the housing in a more or less upright condition and the mouthpiece or nozzle of the inhalation device is placed in the mouth or nose of the patient. The aerosol container is pressed towards the support to dispense a dose of medicament from the container which is then inhaled by the patient.

It is also known to use dry powder inhalation devices for the delivery of inhalable medicament. In one aspect, such dispensers comprise pre-metered doses of powdered medicament, for example in capsules or blisters. In another aspect, such dispensers comprise a reservoir of powdered medicament from which doses are metered prior to or concurrent with the delivery process. In either case, the device may be designed for passive release of medicament, where the medicament is simply made available at a delivery position for aerosolisation in response to the inhalation of the patient. Alternatively, an active release mechanism may be used whereby a ‘puff’ of gas or air is provided to the delivery position to assist in aerosolisation of the powder prior to or concurrent with the inhalation of the patient. Such devices are generally called active release dry powder inhalers (active DPIs). The source of the compressed gas or air is generally an aerosol container but can also be provided by another suitable means such as a pump or plunger mechanism.

It is also well known to use syringes for the delivery of injectable medicament to a patient. Traditional syringes rely on puncturing of the patient's skin by a hollow needle through which the injectable medicament (in solution or suspension form) is delivered to the muscle or tissue of the patient. Recently developed needleless systems for the delivery of injectables employ high velocity injection of particle formulated drugs or vaccine through the skin and into any physically accessible tissue. Other needleless systems employ similar high velocity injection of drug or vaccine coated on to a suitable carrier particle. Such needleless systems may be configured to include a source of compressed air or gas, which on release provides energy to propel the medicament particles for injection into the skin.

It may be understood that effective delivery of medicament to the patient using an inhalation device such as an MDI or active DPI as described above is to an extent dependent on the patient's ability to manually actuate the device (e.g. firing of the aerosol) and to co-ordinate the actuation thereof with the taking of a sufficiently strong inward breath. For some patients, particularly young children, the elderly and the arthritic, manual actuation of the device can present difficulties. Other patients find it difficult to co-ordinate the taking of a reliable inward breath with actuation of the device. Both of these sets of patients run the risk that they do not receive the appropriate dose of medicament.

It may also be understood that effective delivery of medicament to the patient using a syringe or needleless injection system as described above also requires care and dexterity.

The Applicants have now developed a medicament dispenser which does not require controlled manual actuation by the patient. In one aspect, the dispenser comprises a medicament container having a dispensing mechanism such as a valve or plunger and an actuator for actuating the dispensing mechanism. In another aspect, the device comprises an active DPI or needless injection system having a source of compressed air or gas having a dispensing mechanism such as a valve or plunger and an actuator for actuating the dispensing mechanism. Actuation is responsive to the application of non-mechanical (e.g. electrical) energy to drive means of the actuator. The non-mechanical energy can in turn be provided in response to the sensing of the breath of a patient.

The Applicants have found that a particularly suitable drive means comprises an electrically-powered motor in association with a gear mechanism. The gear mechanism increases the torque (force) delivered to the actuator which thereby enables relatively compact, low power and low torque producing motors to be employed. Compactness is a key requirement of portable medicament dispensers, particularly those designed for hand-held use and/or pocket portability.

The Applicants have also found that enhanced utility can be obtained if electronic control systems are provided to control the operation of the drive means.

According to one aspect of the present invention there is provided a medicament dispenser comprising a housing; a medicament container having a dispensing mechanism; a container seat for receipt of the container; an anchor station on the housing or connecting therewith; and drive means capable of moving the container seat relative to the anchor station to actuate the dispensing mechanism, the drive means being actuable in response to the application of non-mechanical energy thereto, wherein gear means are provided to said drive means to gear up the torque provided thereby.

According to another aspect of the present invention there is provided a medicament dispenser comprising a medicament container having a dispensing mechanism; a container seat for receipt of the container; a dispenser seat for receipt of the dispensing mechanism; and drive means capable of moving the container seat relative to the dispenser seat to actuate the dispensing mechanism, the drive means being actuable in response to the application of non-mechanical energy thereto, wherein gear means are provided to said drive means to gear up the torque provided thereby.

According to a further aspect of the present invention there is provided a medicament dispenser comprising a housing; a medicament container for containing medicament for release; an aerosol container having a dispensing mechanism; a container seat for receipt of the aerosol container; an anchor station on the housing or connecting therewith; and drive means capable of moving the container seat relative to the anchor station to actuate the dispensing mechanism to energise released medicament, the drive means being actuable in response to the application of non-mechanical energy thereto, wherein gear means are provided to said drive means to gear up the torque provided thereby.

According to a further aspect of the present invention there is provided a medicament dispenser comprising a medicament container for containing medicament for release; an aerosol container having a dispensing mechanism; a container seat for receipt of the container; a dispenser seat for receipt of the dispensing mechanism; and drive means capable of moving the container seat relative to the dispenser seat to actuate the dispensing mechanism to energise released medicament, the drive means being actuable in response to the application of non-mechanical energy thereto, wherein gear means are provided to said drive means to gear up the torque provided thereby.

Suitably, in accord with the two aspects introduced directly above, the medicament container comprises a release mechanism for releasing medicament therefrom, such as a valve or other suitable mechanism which may also provide a metering function. In another aspect, the medicament container may be arranged for rupture in response to firing of the aerosol container, thereby making the medicament contents thereof available for energisation. In one aspect, the medicament dispenser is in the form of an active DPI in which a ‘puff’ of air or gas (e.g. helium) is delivered from an aerosol container, pump or plunger mechanism to aerosolise a dose of released dry powder medicament. In another aspect, the medicament dispenser is in the form of a needless injection system in which compressed air or gas (e.g. helium) is delivered at high velocity from the aerosol container to propel a dose of dry powder medicament for injection into the skin. Thus, suitably the aerosol container, which as used herein refers to any suitable container for comprising liquefied gas under pressure, comprises a compressed air or gas (e.g. helium).

The release mechanism comprises means for the making medicament available from the medicament container for release to the patient. The release may be active in the sense that medicament is actively dispensed from the container, or the release may be passive in the sense that medicament is merely made available for release when the release means is actuated. Release may be to a delivery position for delivery to the patient, or alternatively there may be a further transport step in which the medicament is transported from a non-delivery, position, to a position where the drug is ready for delivery to the patient.

In one aspect, the medicament is pre-metered prior to release. For example, the medicament is pre-metered in capsules, strip or tape form.

In another aspect, the medicament container comprises a reservoir for medicament (e.g. tin powder form) and a meter is provided for metering an amount (e.g. by volume or by weight) of medicament from said reservoir.

Suitably, the dispensing mechanism is selected from the group consisting of a valve, pump or plunger mechanism. Preferably, the dispensing mechanism comprises a metering mechanism.

In one aspect, the dispensing mechanism comprises a valve. Suitably, the valve is a slide valve. Other valve systems include, but are not limited to, poppet valve systems, wedge gate valve systems, double-disc gate valve systems, globe and angle valve systems, swing check valve systems, end cock valve systems, and other like valve systems. The valve design is typically a function of providing a predetermined dosage or amount of the medicament contained within the container to a user.

Where the medicament container is a pressurized aerosol container, the valve typically comprises a valve body having an inlet port through which a medicament aerosol formulation may enter said valve body, an outlet port through which the aerosol may exit the valve body and an open/close mechanism by means of which flow through said outlet port is controllable.

The valve may be a slide valve wherein the open/close mechanism comprises a sealing ring and receivable by the sealing ring a valve stem having a dispensing passage, the valve stem being slidably movable within the ring from a valve-closed to a valve-open position in which the interior of the valve body is in communication with the exterior of the valve body via the dispensing passage.

Typically, the valve is a metering valve. The metering volumes are typically from 10 to 100 μl, such as 25 μl, 50 μl or 63 μl. Suitably, the valve body defines a metering chamber for metering an amount of medicament formulation and an open/close mechanism by means of which the flow through the inlet port to the metering chamber is controllable. Preferably, the valve body has a sampling chamber in communication with the metering chamber via a second inlet port, said inlet port being controllable by means of an open/close mechanism thereby regulating the flow of medicament formulation into the metering chamber.

The valve may also comprise a ‘free flow aerosol valve’ having a chamber and a valve stem extending into the chamber and movable relative to the chamber between dispensing and non-dispensing positions. The valve stem has a configuration and the chamber has an internal configuration such that a metered volume is defined therebetween and such that during movement between is non-dispensing and dispensing positions the valve stem sequentially: (i) allows free flow of aerosol formulation into the chamber, (ii) defines a closed metered volume for pressurized aerosol formulation between the external surface of the valve stem and internal surface of the chamber, and (iii) moves with the closed metered volume within the chamber without decreasing the volume of the closed metered volume until the metered volume communicates with an outlet passage thereby allowing dispensing of the metered volume of pressurized aerosol formulation. A valve of this type is described in U.S. Pat. No. 5,772,085.

The valve may also have a structure and action similar to those aerosol valves described in European Patent Application No. EP-A-870,699 and PCT Patent Application No. WO99/36334.

In another aspect, the dispensing mechanism comprises a plunger, such as might exist in a syringe for the delivery of injectable medicament to a patient. Embodiments including multiple plungers and multiple syringe chambers are also envisaged. The syringe contents may for example, be liquid, solutions, suspensions, particulates or in freeze-dried form. A retract or reset mechanism is typically provided for the plunger.

Traditional syringes rely on puncturing of the patient's skin by a hollow needle through which the injectable medicament (in solution or suspension form) is delivered to the muscle or tissue of the patient. Recently developed needleless systems for the delivery of injectables employ high velocity injection of particle formulated drugs or vaccine through the skin and into any physically accessible tissue. Other needleless systems employ similar high velocity injection of drug or vaccine coated on to a suitable carrier particle.

In another aspect, the dispensing mechanism comprises a pump mechanism such as might be found in a dispenser for dispensing liquid or solution (e.g. aqueous solution) form medicament. The pump may deliver the medicament directly to the patient (e.g. as a nasal spray) or the pump may deliver the medicament to an intermediate position at which further energy is supplied thereto to further propel, aerosolise or otherwise direct the medicament dose to the patient.

A reset mechanism may be provided for resetting the dispensing mechanism after actuation thereof. The reset mechanism may for example, comprise a spring, motor, mechanical arrangement or a reset coupling. The reset mechanism may in aspects, form part of the dispensing mechanism or part of the drive means. Alternatively, it may be an entirely separate mechanism.

The term ‘non-mechanical energy’ herein is used to mean essentially any energy type which is not mechanical energy. Examples include electrical current energy, electrical field energy and magnetic field energy.

The term ‘drive means’ is used herein to define any means capable of providing the required drive action. The drive suitably allows for movement to reverse the drive action. Thus, it suitably allows for both actuation and resetting of the dispensing mechanism. Whilst, the drive action is almost always powered, the return action may be powered or it may be a simple, unpowered relax action or a combination of these alternatives.

The drive means may also be configured to agitate (e.g. vibrate or shake) the medicament container at any point during the drive action.

The drive means typically comprises a motor, preferably an electrically-powered motor. The motor may provide linear or rotary drive. The motor may for example, comprise an AC electric motor, a DC electric motor, a piezoelectric (PZ) motor (or ultrasonic (US) motor), a solenoid motor or a linear motor.

The use of ultrasonic motors is particularly preferred since they offer advantages over conventional motors in terms of weight, size, noise, cost and torque generated. Several different types of US motors are well known in the art. Thus ‘lamellar’, ‘ring’ and ‘hybrid’ US motors are commercially available from, for example, BMSTU Technological Cooperation Centre Ltd, Moscow, Russia; Shinsei Corporation, Tokyo, Japan; and Creaholic S A, Biel, Switzerland.

Ultrasonic motors do not use coils or magnets but comprise a piezo-electric ceramic stator which drives a coupled rotor. The stator generates ultrasonic vibrations which in turn causes rotation of the rotor. Rotation can be made to be bi-directional by simply coupling two stator elements together in a serial manner. While regular DC motors are characterised by high speed and low torque, requiring reduction gearing to increase torque, US motors attain low speed and high torque, thus eliminating the need for reduction gearing. Furthermore these motors are lightweight and compact, lacking coils and magnets, thus reducing costs, operating at low voltages (e.g. 1 to 24 volts) and being noiseless to the human ear.

The drive means may also comprise a fluid pump such as an air pump or hydraulic pump.

The drive means may also comprise a servo system, incorporating a closed loop feedback system consisting of a controller, amplifier and feedback device. The controller allows a desired actuation profile to be programmed and the feedback device provides an error signal in the event of a deviation from the programmed actuation profile. Any error is compensated for by the controller which controls the drive means via the amplifier in order to reduce the error signal to a predetermined acceptable level. The desired actuation profile may be defined in terms of position, velocity, torque or acceleration over a predetermined time period.

The drive means may have direct driving action such that actuation thereof results directly in actuation of the dispensing mechanism. Alternatively, the drive means may be coupled through some sort of coupling to the container seat/dispenser seat. This coupling may be a direct coupling or it may comprise some sort of energy storage mechanism or trigger mechanism. Embodiments are for example, envisaged in which the drive means is used to provide energy to a sprung trigger system, the actuation of which results in movement of the container seat/dispenser seat to actuate the dispensing mechanism.

The drive means additionally comprises (or is provided or associated with) gear means to gear up the torque (force) provided thereby (e.g. by the motor or pump). This enables motors of relatively low torque (which are typically compact, high speed and with low power requirements) to be employed.

The Applicants have determined that gear ratios of from 20:1 to 1000:1, particularly from 50:1 to 500:1, preferably 100:1 to 200:1 are most suitable.

In a particular example, the force required to actuate the valve of a typically metered dose inhaler (MDI) dispenser is from 20 to 40N. But if a gear means is employed motors capable of providing torque of less than 1 N.m may be employed.

The gear means may comprise any suitable gear mechanism. Specific examples include cam gears, screw drives, levers, crank shafts, pulleys and hydraulic gears. Preferably, the gear mechanism is relatively compact.

It is envisaged that the medicament dispenser herein may be configured for use with medicament containers of varying sizes, shapes and/or manufacturing tolerances. It is therefore desirable that the medicament dispenser herein comprises locator means to locate the position, velocity, torque and/or acceleration of the medicament container. The locator may also act such as to continually track the position of the medicament container e.g. during any particular drive operation. The medicament dispenser also preferably comprises zeroing means to position the medicament container at a defined zero position therein. The controller corrects for errors in the position, velocity, torque or acceleration profile of the drive means.

The locator, tracker and/or zeroing means may comprise mechanical and/or electronic components such as any known electronic position sensing means.

Suitably, the drive means is actuable in response to electrical current flow in the range from 0.01 A to 100 A, preferably from 0.1 A to 5 A. Any known systems for power management and conservation may be employed with the electrical energy source to manage and/or conserve the power output thereof.

Energy may be conserved by a variety of means to enable the device to operate for longer on a given source of energy, such as a battery. Energy conservation or saving methods have additional advantages in terms of reducing the size requirements of the power source (e.g. battery) and thus the weight and portability of the inhalation device.

A variety of energy saving methods are available which generally involve reducing power consumption. One such method is to use a clock or timer circuit to switch the power on and off at regular or predetermined intervals. In another method the system can selectively switch on/off specific electronic devices, such as visual display units or sensors, in order to power these devices only when they are required to perform a particular sequence of events. Thus different electronic devices may be switched on and off at varying intervals and for varying periods under control of the system. The power sequencing system may also respond to a sensor, such as a motion or breath sensor, which is activated on use of the device.

Low power or “micropower” components should be used within the electronics where possible and if a high power device is required for a particular function this should be put into a low power standby mode or switched off when not required. Similar considerations apply in the selection of transducers. Operation at low voltage is desirable since power dissipation generally increases with voltage.

For low power digital applications complementary metal oxide semi-conductor (CMOS) devices are generally preferred and these may be specially selected by screening for low quiescent currents. Clock speeds of processors and other logic circuits should be reduced to the minimum required for computational throughput as power consumption increases with frequency. Supply voltages should also be kept at minimal values consistent with reliable operation because power dissipation in charging internal capacitance's during switching is proportional to the square of the voltage. Where possible, supply voltages should be approximately the same throughout the circuit to prevent current flowing through input protection circuits. Logic inputs should not be left floating and circuits should be arranged so that power consumption is minimised in the most usual logic output state. Slow logic transitions are undesirable because they can result in relatively large class-A currents flowing. Resistors may be incorporated in the power supply to individual devices in order to minimise current in the event of failure.

In some control applications, devices that switch between on and off states are preferred to those that allow analog (e.g. linear) control because less power is dissipated in low resistance on states and low current off states. Where linear components are used (e.g. certain types of voltage regulators) then types with low quiescent currents should be selected. In some circuit configurations it is preferable to use appropriate reactive components (i.e. inductors and capacitors) to reduce power dissipation in resistive components.

Any electrical circuit may incorporate voltage amplification means for generating a higher voltage than that supplied by the voltaic cell or battery of voltaic cells, for example a step-up or inverting switching circuit or a dc-dc converter incorporating an oscillator, transformer and rectifier.

The electrical circuit may incorporate one or more energy storage components such as capacitors or inductors in order to supply a high enough instantaneous current to drive the drive means.

The input to the electrical circuit may be connected to the electrical energy source by means of a mechanical, electromechanical or electronic switching component.

The output of the electrical circuit may be connected to the drive or any reset mechanism by means of a mechanical, electromechanical or electronic switching component or by a component allowing the output current to be controlled in a linear or digital (e.g. pulse width modulated) manner.

In aspects, the drive means may be powered from the battery using a switching component without additional power supply circuitry.

Suitably, the medicament dispenser additionally comprises a regulator for controlling the amount of electrical current flow to the drive means. Preferably, the regulator comprises a timer for controlling the duration of electrical current flow to the drive means.

Suitable control profiles (e.g. via pulse width modulation) include those where the drive means is initially moved to an engagement position in which it just engages the container. Actuation is then achievable by moving the drive means through its normal driving stroke which stroke can itself be the subject of any suitable control profile. In one aspect, the stroke is monitored to detect a stop point (e.g. as defined by the hard stop of a slide valve).

The control profile can in aspects be arranged to be responsive to one or more sensors which e.g. sense characteristics of the engagement and drive actions. Suitable sensors include those which measure movement, pressure, force (torque) or other relevant characteristics. Preferably the sensor monitors the electrical current flow to the drive means.

Suitably, the medicament dispenser additionally comprises a local electrical store such as a capacitor or inductor.

Suitably, the medicament dispenser is provided with a manual override to enable actuation of the dispenser in the event of loss of electrical power.

Suitably, the medicament dispenser is provided with child-resistance features to prevent undesirable actuation thereof by a young child.

In one aspect, the container is an aerosol container, preferably comprising a metering valve at the dispensing outlet. In another aspect, the container is for medicament in solution form (e.g aqueous solution) comprising a pump dispensing mechanism.

In one aspect, the aerosol container comprises a suspension of a medicament in a propellant. The propellant preferably comprises liquefied HFA134a, HFA-227, helium or carbon dioxide.

In another aspect, the aerosol container comprises a solution of a medicament in a solvent.

The medicament is preferably selected from the group consisting of albuterol, salmeterol, fluticasone propionate, beclomethasone dipropionate, ipratropium salts or solvates thereof and any mixtures thereof. Alternatively, the dispenser may be employed for dispensing vaccine.

Preferably, the valve is a slide valve.

Preferably, the valve is a metering valve. In alternative embodiments, metering of medicament dose may be achievable by pulsing electrical current flow through the drive means for a selected dispensing time.

Preferably, the container seat is shaped for snug receipt of the base of the medicament container or aerosol container. Preferably, the dispenser seat is shaped for snug receipt of the tip of the dispensing mechanism. More preferably, the dispenser seat is further shaped to support the walls of the medicament container or aerosol container. Most preferably, the container seat and dispenser seat in combination form a cradle for the medicament container or aerosol container.

Preferably, actuation of the drive means and hence the dispensing mechanism is responsive to a patient-actuable trigger.

In one aspect, said trigger comprises a button, switch or lever arrangement.

In another aspect, the medicament dispenser is in the form of an inhaler for the delivery of inhalable medicament. Inhalation may be through the nose or the mouth. Preferably, actuation of the drive means and hence the dispensing mechanism is responsive to a patient-actuable trigger comprising a sensor which senses the breath of a patient. The actuation of the drive means (e.g. in response to the input of electrical current) may be responsive to the detection of the inward breath of a patient. Alternatively, the actuation may be responsive to a trigger coupled to any point in the breathing pattern of the patent, such as the end of the outward breath.

In one aspect, the sensor comprises a breath-movable element which is movable in response to the breath of a patient. Preferably, the breath-movable element is selected from the group consisting of a vane, a sail, a piston, a diaphragm and an impeller.

Movement of the breath-movable element may be detectable by any suitable technique for detecting movement. Suitable techniques include optical detectors, magnetic detectors or detectors using detection of capacitative effects.

Optical detectors may be used to detect movement of the breath-movable element by providing the element with a patterned outer surface, for example strips in a barcode type arrangement, and locating the optical detector so that it points towards the patterned surface. Movement of the breath-movable element alters the amount of the light source which reflects back onto the optical detector as the beam passes over the patterned surface. The strips may be arranged so that the direction of movement of the element can be detected.

Magnetic detectors may be used to detect the movement of breath-movable element by the use of a magnetic switch device. A reader is located on the dispenser and magnetic material embedded within the breath-movable element (or vice-versa). Movement of the breath-movable element results in a change of the magnetic field experienced by the reader. Alternatively, a Hall effect device can be used whereby a semiconductor measures the strength of the magnetic field of the magnetic material on the breath-movable element.

Detection of capacitative effects may be used to detect movement of the breath-movable element by adding a conductive part to the element and also to a second fixed part of the dispenser. Movement of the breath-movable element results in a change in capacitance which can be measured.

In another aspect, the sensor comprises a pressure sensor for sensing the pressure profile associated with the breath of a patient. A pressure transducer is an example of a suitable pressure sensor.

In another aspect, the sensor comprises an airflow sensor for sensing the airflow profile associated with the breath of a patient.

In another aspect, the sensor comprises a temperature sensor for sensing the temperature profile associated with the breath of a patient.

In another aspect, the sensor comprises a moisture sensor for sensing the moisture profile associated with the breath of a patient.

In another aspect, the sensor comprises a gas sensor for sensing the oxygen or carbon dioxide profile associated with the breath of a patient. The chemical profile of the inhaled and exhaled part of the breath cycle varies and this further may be used as a measurement tool.

Suitably, the breath data includes breath cycle data, FEV, and/or peak flow data.

Preferably the medicament dispenser comprises an actuation or dose counter for counting the number of actuations of the drive and/or dispensing mechanism or releases of dose therefrom. The actuation or dose counter may be mechanical or electronic. More preferably the actuation or dose counter is independent of the drive means so that counting will occur even if the dispensing mechanism is manually actuated.

Preferably a manual override is provided to enable manual actuation of the dispensing mechanism. The manual override may be designed to cover all situations in which the drive means does not actuate in the normal manner. These will include situations where actuation does not happen (e.g. due to power failure). Alternatively, this will include situations where actuation occurs, but reset of the drive means fails (e.g. due to power being in a ‘continuous on’ mode) and a manual reset (e.g. by introducing a ‘circuit break’) is employed.

Suitably, the medicament dispenser additionally comprises an electronic data management system. The electronic data management system has input/output capability and comprises a memory for storage of data; a microprocessor for performing operations on said data; and a transmitter for transmitting a signal relating to the data or the outcome of an operation on the data.

Suitably, the electronic data management system comprises an electronic control system for controlling the supply of energy to the drive means. Thus, in aspects the control system may regulate flow of electrical current to the drive means or to any heater or electromagnet source associated therewith.

The control system may form part of a larger electronic data management system capable of receiving inputs from other electronic components. In particular, inputs may be received from any sensor to enable actuation of the drive means in response to sensor, particularly breath sensor input.

The control system may be arranged to accomplish any suitable control of actuation of the drive means including varying the amount of energy supplied thereto, the rate of energy supplied thereto, pulsing patterns of energy supply to the drive means, and more complex control patterns.

Suitably, the electronic data management system is arranged to be responsive to or activated by the voice of a user. Thus, for example the system may be switched on or off in response to a voice command.

The electronic data management system may be integral with the body. Alternatively, the electronic data management system forms part of a base unit which is reversibly associable with the body.

Suitably, the medicament dispenser additionally comprises a data input system for user input of data to the electronic data management system. Preferably, the data input system comprises a man machine interface (MMI) preferably selected from a keypad, voice or noise recognition interface, graphical user interface (GUI) or biometrics interface.

Suitably, the system additionally comprises a visual display unit for display of data from the electronic data management system to the user. The display may for example, comprise a screen such as an LED or LCD screen. More preferably the visual display unit is associable with the housing. More basic display units are envisaged also including those in which a light or pattern of lights is employed to act as a signal to the patient.

The electronic data management system may further comprise a voice synthesiser for verbal communication of data, instructions and feedback to a user.

Suitably, the medicament dispenser additionally comprises a datalink for linking to a local data store to enable communication of data between the local data store and the electronic data management system. The datastore may also comprise data management, data analysis and data communication capability.

The datastore may itself form part of a portable device (e.g. a handheld device) or it may be sized and shaped to be accommodated within the patient's home. The datastore may also comprise a physical storage area for storage of replacement medicament containers. The datastore may further comprise a system for refilling medicament from a reservoir of medicament product stored therewithin. The datastore may further comprise an electrical recharging system for recharging any electrical energy store on the medicament dispenser, particularly a battery recharging system.

The datalink may for example enable linking with a docking station, a personal computer, a network computer system or a set-top box by any suitable method including a hard-wired link, an infra red link or any other suitable wireless communications link.

Suitably, the medicament dispenser additionally comprises an actuation detector for detecting actuation of the dispensing mechanism wherein said actuation detector transmits actuation data to the electronic data management system.

The medicament dispenser may additionally comprise a safety mechanism to prevent unintended multiple actuations of the dispensing mechanism. The patient is thereby protected from inadvertently receiving multiple doses of medicament in a situation where they take a number of short rapid breaths. More preferably, the safety mechanism imposes a time delay between successive actuations of the release means. The time delay is typically of the order of from three to thirty seconds.

Suitably, the medicament dispenser additionally comprises a release detector for detecting release of medicament from the medicament container, wherein said release detector transmits release data to the electronic data management system.

Suitably, the medicament dispenser additionally comprises a shake detector for detecting shaking of the medicament container (e.g. prior to actuation of the dispensing mechanism), wherein said shake detector transmits shake data to the electronic data management system.

Suitably, any actuation detector, release detector or shake detector comprises a sensor for detecting any suitable parameter such as movement. Any suitable sensors are envisaged including the use of optical sensors. The release detector may sense any parameter affected by release of the medicament such as pressure, temperature, sound, moisture, carbon dioxide concentration and oxygen concentration.

Suitably, the medicament dispenser additionally comprises a breath trigger for triggering the dispensing mechanism, said breath trigger being actuable in response to a trigger signal from the electronic data management system. Preferably, the electronic data management system includes a predictive algorithm or look-up table for deriving from the breath data when to transmit the trigger signal. For example, a real-time analysis of the patient breath waveform may be made and the trigger point derived by reference to that analysed waveform.

Suitably, the electronic data management system includes a predictive algorithm or look-up table for calculating the optimum amount of medicament to dispense.

Suitably, the memory on the electronic data management system includes a dose memory for storing dosage data and reference is made to the dose memory in calculating the optimum amount of medicament to dispense.

Suitably, the medicament dispenser additionally comprises a selector for selecting the amount of medicament to dispense from said dispensing mechanism. In one aspect, the selector is manually operable. In another aspect, the selector is operable in response to a signal from the transmitter on the electronic data management system.

Suitably, the medicament dispenser comprises in association with a body or housing thereof, a first transceiver for transmitting and receiving data and in association with the medicament container, a second transceiver for transmitting and receiving data, wherein data is transferable in two-way fashion from the first transceiver to the second transceiver. The data is preferably in digital form and suitable for transfer by electronic or optical means. A medicament dispenser of this general type is described in pending UK Patent Application No. 0020538.5 (PG4128).

The body or housing of the medicament dispenser is typically shaped to define a cavity within which the medicament container is receivable. The body and/or medicament container may be further shaped with any manner of grooves, indentations or other shaping or surface details to define a ‘lock and key’ relationship between the body and the container. Colour guides, arrows and any other surface markings may also be employed.

One advantage of embodiments of this type is the ability to store many types of information in different parts of the memory structure of the transceivers. The information is furthermore stored in a form which is readily and accurately transferable. The information could for example, include manufacturing and distribution compliance information written to the memory at various points in the manufacturing or distribution process, thereby providing a detailed and readily accessible product history of the dispenser. Such product history information may, for example, be referred to in the event of a product recall. The compliance information could, for example, include date and time stamps. The information could also include a unique serial number stored in encrypted form or in a password protectable part of the memory which uniquely identifies the product and therefore may assist in the detection and prevention of counterfeiting. The information could also include basic product information such as the nature of the medicament and dosing information, customer information such as the name of the intended customer, and distribution information such as the intended product destination.

On loading or reloading the dispenser with a medicament container (such as an aerosol canister or dry powder cassette) the second transceiver may, for example, read the unique serial number, batch code and expiry date of the medicament and any other information on the second transceiver. In this way the nature and concentration of the medicament, together with the number of doses used or remaining within the container, may be determined. This information can be displayed to the patient on a visual display unit. Other information, such as the number of times the dispenser has been reloaded with a medicament container, may also be displayed.

Similarly, should the container be removed from the housing before the supply of medicament is exhausted, the same data can be read from the second transceiver and the number of doses remaining or used determined. Other information, such as the date and time of administration of the drug, or environmental exposure data such as the minimum/maximum temperatures or levels of humidity the medicament container has been exposed to, may also be read and displayed to the user.

In the event that the supply of medicament within the container becomes exhausted, or that the shelf life of the medicament has expired, or that the first transceiver does not recognise the batch code on the second transceiver, activation of the dispenser may be prevented to safeguard the user. Activation may also be prevented if the medicament has been exposed to extreme environmental conditions for periods outwith the manufacturer's guidelines.

Data may be transferred to and from any transceiver during the period of use of the medicament dispenser by the patient. For example, the medicament dispenser may include an electronic data management system having various sensors associated therewith. Any data collected by the sensors or from any data collection system associated with the electronic data management system including a clock or other date/time recorder is transferable.

Data may be transferred each time the patient uses the device. Or alternatively, data may be stored in a database memory of the electronic data management system and periodically downloaded to any transceiver. In either case, a history of the usage of the device may be built up in the memory of a transceiver.

In one embodiment herein, a history of the usage of the medicament dispenser is transferred to the second transceiver on the aerosol container. When the medicament container is exhausted it is exchanged by the patient for a new refill container. At the point of exchange, which will typically occur at the pharmacy, data may be transferred from the exhausted container to the refill and vice-versa. Additionally, usage history data may be read from the refill and transferred to a healthcare data management system for example comprising a network computer system under the control of a healthcare data manager.

Methods are envisaged herein whereby the patient is given some sort of reward for returning the refill and making available the data comprised within the second transceiver. Methods are also envisaged herein whereby the healthcare data manager is charged for either receipt of the data from the second transceiver or for its use for commercial purposes. Any rewards or charging may be arranged electronically. The methods may be enabled by distributed or web-based computer network systems in which any collected data is accessible through a hub on the network. The hub may incorporate various security features to ensure patient confidentiality and to allow selective access to information collected dependent upon level of authorisation. The level of user authorisation may be allocated primarily to safeguard patient confidentiality. Beyond this the level of user authorisation may also be allocated on commercial terms with for example broader access to the database being authorised in return for larger commercial payments.

Suitably, the first and second transceiver each comprise an antenna or equivalent for transmitting or receiving data and connecting thereto a memory. The memory will typically comprise an integrated circuit chip. Either transceiver may be configured to have a memory structure which allows for large amounts of information to be stored thereon. The memory structure can be arranged such that parts of the memory are read-only, being programmed during/after manufacture, other parts are read/write and further parts are password protectable. Initial transfer of information (e.g. on manufacture or one dispensing) to or from any transceiver can be arranged to be readily achievable by the use of a reader which is remote from the medical dispenser, thereby minimising the need for direct product handling. In further aspects, the reader can be arranged to simultaneously read or write to the memory of multiple transceivers on multiple medicament dispensers.

A suitable power source such as a battery, clockwork energy store, solar cell, fuel cell or kinetics-driven cell will be provided as required to any electronic component herein. The power source may be arranged to be rechargeable or reloadable.

Suitably, data is transferable in two-way fashion between the first and second transceiver without the need for direct physical contact therebetween. Preferably, data is transferable wirelessly between the first and second transceiver.

Suitably, the first transceiver is an active transceiver and the second transceiver is a passive transceiver. The term active is used to mean directly powered and the term passive is used to mean indirectly powered.

Suitably, the second transceiver comprises a label or tag comprising an antenna for transmitting or receiving energy; and an integrated circuit chip connecting with said antenna, and the first transceiver comprises a reader for said label or tag. In this case the label or tag is a passive transceiver and the reader is an active transceiver. Preferably, the reader will not need to be in direct contact with the tag or label to enable the tag or label to be read.

The tag may be used in combination and/or integrated with other traditional product labelling methods including visual text, machine-readable text, bar codes and dot codes.

Suitably, the integrated circuit chip has a read only memory area, a write only memory area, a read/write memory area or combinations thereof.

Suitably, the integrated circuit chip has a one-time programmable memory area. More preferably, the one-time programmable memory area contains a unique serial number.

Suitably, the integrated circuit chip has a preset memory area containing a factory preset, non-changeable, unique data item. The preset memory item is most preferably in encrypted form.

Suitably, the integrated circuit chip has plural memory areas thereon. Suitably, any memory area is password protected.

Suitably, any memory area contains data in encrypted form. Electronic methods of checking identity, error detection and data transfer may also be employed.

In one aspect, the integrated circuit has plural memory areas thereon including a read only memory area containing a unique serial number, which may for example be embedded at the time of manufacture; a read/write memory area which can be made read only once information has been written thereto; and a password protected memory area containing data in encrypted form which data may be of anti-counterfeiting utility.

Suitably, the tag is-on a carrier and the carrier is mountable on the body or housing of the medicament dispenser or the medicament container.

In one aspect, the carrier is a flexible label. In another aspect, the carrier is a rigid disc. In a further aspect, the carrier is a rectangular block. In a further aspect, the carrier is a collar ring suitable for mounting to the neck of an aerosol container. Other shapes of carrier are also envisaged.

Suitably, the carrier is mouldable or weldable to the medicament container or housing. Suitably, the carrier encases the tag. More preferably, the carrier forms a hermetic seal for the tag.

In one aspect, the carrier comprises an insulating material such as a glass material or, a paper material or an organic polymeric material such as polypropylene. Alternatively, the carrier comprises a ferrite material.

The energy may be in any suitable form including ultrasonic, infrared, radiofrequency, magnetic, optical and laser form. Any suitable channels may be used to channel the energy including fibre optic channels.

In one aspect, the second transceiver comprises a radiofrequency identifier comprising an antenna for transmitting or receiving radiofrequency energy; and an integrated circuit chip connecting with said antenna, and the first transceiver comprises a reader for said radiofrequency identifier. In this case the radiofrequency identifier is a passive transceiver and the reader is an active transceiver. An advantage of radiofrequency identifier technology is that the reader need not be in direct contact with the radiofrequency identifier tag or label to be read.

The radiofrequency identifier can be any known radiofrequency identifier. Such identifiers are sometimes known as radiofrequency transponders or radiofrequency identification (RFID) tags or labels. Suitable radiofrequency identifiers include those sold by Phillips Semiconductors of the Netherlands under the trade marks Hitag and Icode, those sold by Amtech Systems Corporation of the United States of America under the trade mark Intellitag, and those sold by Texas Instruments of the United States of America under the trade mark Tagit.

Suitably, the antenna of the RFID tag is capable of transmitting or receiving radiofrequency energy having a frequency of from 100 KHz to 2.5 GHz. Preferred operating frequencies are selected from 125 KHz, 13.56 MHz and 2.4 GHz.

In one aspect, the second transceiver comprises a magnetic label or tag comprising an antenna for transmitting or receiving magnetic field energy; and an integrated circuit chip connecting with said antenna, and the first transceiver comprises a reader for said magnetic label or tag. In this case the magnetic label or tag is a passive transceiver and the reader is an active transceiver.

A suitable magnetic label or tag comprises plural magnetic elements in mutual association whereby the magnetic elements move relative to each other in response to an interrogating magnetic field. A magnetic label or tag of this type is described in U.S. Pat. No. 4,940,966. Another suitable magnetic label or tag comprises a magnetorestrictive element which is readable by application of an interrogating alternating magnetic field in the presence of a magnetic bias field which results in resonance of the magnetorestrictive elements at different predetermined frequencies. A magnetic label of this type is described in PCT Patent Application No. WO92/12402. Another suitable magnetic label or tag comprising plural discrete magnetically active regions in a linear array is described in PCT Patent Application No. WO96/31790. Suitable magnetic labels and tags include those making use of Programmable Magnetic Resonance (PMR) (trade name) technology.

In another aspect, the second transceiver comprises a microelectronic memory chip and the first transceiver comprises a reader for said microelectronic memory chip. The microelectronic memory chip may comprise an Electrically Erasable Programmable Read Only Memory (EEPROM) chip or a SIM card-type memory chip. In this case the microelectronic memory chip is a passive transceiver and the reader is an active transceiver.

Any transceiver herein, particularly a passive transceiver may be mounted on or encased within any suitable inert carrier. The carrier may comprise a flexible sheet which may in embodiments be capable of receiving printed text thereon.

In one aspect, the first transceiver is integral with the body such that a single unit is comprised. The first transceiver may for example be encased within or moulded to the body.

In another aspect, the first transceiver forms part of a base unit which is reversibly associable with the body. The base unit may for example, form a module receivable by the body such as a snap-in module.

Suitably, the medicament dispenser additionally comprises a communicator for wireless communication with a network computer system to enable transfer of data between the network computer system and the electronic data management system. Dispensers employing such communicators are described in pending PCT Applications No.s PCT/EP00/09291 (PG3786), PCT/EP00/09293 (PG4029) and PCT/EP00/09292 (PG4159). Preferably, the communicator enables two-way transfer of data between the network computer system and the electronic data management system.

Suitably, the data is communicable between the network computer system and the electronic data management system in encrypted form. All suitable methods of encryption or partial encryption are envisaged. Password protection may also be employed. Suitably, the communicator employs radiofrequency or optical signals.

In one aspect, the communicator communicates via a gateway to the network computer system. In another aspect, the communicator includes a network server (e.g. a web server) such that it may directly communicate with the network.

In a further aspect, the communicator communicates with the gateway via a second communications device. Preferably, the second communications device is a telecommunications device, more preferably a cellular phone or pager. Preferably, the communicator communicates with the second communications device using spread spectrum radiofrequency signals. A suitable spread spectrum protocol is the Bluetooth (trade mark) standard which employs rapid (e.g. 1600 times a second) hopping between plural frequencies (e.g. 79 different frequencies). The protocol may further employ multiple sending of data bits (e.g. sending in triplicate) to reduce interference.

In one aspect, the network computer system comprises a public access network computer system. The Internet is one suitable example of a public access network computer system, wherein the point of access thereto can be any suitable entrypoint including an entrypoint managed by an Internet service provider. The public access network computer system may also form part of a telecommunications system, which may itself be either a traditional copper wire system, a cellular system or an optical network.

In another aspect, the network computer system comprises a private access network computer system. The private access network system may for example, comprise an Intranet or Extranet which may for example, be maintained by a health service provider or medicament manufacturer. The network may for example include password protection; a firewall; and suitable encryption means.

Preferably, the communicator enables communication with a user-specific network address in the network computer system.

The user-specific network address may be selected from the group consisting of a web-site address, an e-mail address and a file transfer protocol address. Preferably, the user-specific network address is accessible to a remote information source such that information from said remote information source can be made available thereto. More preferably, information from the user-specific network address can be made available to the remote information source.

In one aspect, the remote information source is a medicament prescriber, for example a doctor's practice. Information transferred from the medicament prescriber may thus, comprise changes to prescription details, automatic prescription updates or training information. Information transferred to the medicament prescriber may comprise compliance information, that is to say information relating to the patient's compliance with a set prescribing programme. Patient performance information relating for example, to patient-collected diagnostic data may also be transferred to the medicament prescriber. Where the dispenser is an inhaler for dispensing medicament for the relief of respiratory disorders examples of such diagnostic data would include breath cycle data or peak flow data.

In another aspect, the remote information source is a pharmacy. Information transferred from the pharmacy may thus, comprise information relating to the medicament product. Information sent to the pharmacy may thus include prescription requests which have been remotely pre-authorised by the medicament prescriber.

In a further aspect, the remote information source is an emergency assistance provider, for example a hospital accident and emergency service or an emergency helpline or switchboard. The information may thus, comprise a distress or emergency assist signal which requests emergency assistance.

In a further aspect, the remote information source is a manufacturer of medicament or medicament delivery systems. Information transferred to the system may thus, comprise product update information. The system may also be configured to feed information back to the manufacturer relating to system performance.

In a further aspect, the remote information source is a research establishment. In a clinical trial situation, information may thus be transferred relating to the trial protocol and information relating to patient compliance fed back to the research establishment.

In a further aspect, the remote information source is an environmental monitoring station. Information relating to weather, pollen counts and pollution levels may thus be made accessible to the system.

In a further aspect, the remote information source is a computer software download site from which software may be downloaded for use in the electronic data management system. Embodiments are envisaged in which such software downloads are employed to upgrade or modify any existing software employed by the electronic data management system.

Suitably, the medicament dispenser additionally comprises a geographic positioning system such as a global positioning system or a system which relies on the use of multiple communications signals and a triangulation algorithm.

According to another aspect of the present invention there is provided an actuator for a medicament container having a dispensing mechanism comprising a container seat for receipt of the medicament container; a dispenser seat for receipt of the dispensing mechanism; and drive means capable of moving the container seat relative to the dispenser seat to actuate the dispensing mechanism, the drive means being actuable in response to the application of non-mechanical energy thereto, wherein gear means are provided to said drive means to gear up the torque provided thereby.

According to a further aspect of the present invention there is provided an actuator for a medicament container having a dispensing mechanism comprising a housing; within said housing, a container seat for receipt of the medicament container; on the housing or connecting therewith, an anchor station; and drive means capable of moving the container seat relative to the anchor station to actuate the dispensing mechanism, the drive means being actuable in response to the application of non-mechanical energy thereto, wherein gear means are provided to said drive means to gear up the torque provided thereby.

According to a further aspect of the present invention there is provided an actuator for a medicament dispenser having a medicament container and separately an aerosol container having a dispensing mechanism comprising a housing, shaped for receipt of said medicament container for containing medicament for release; within said housing, a container seat for receipt of said aerosol container having a dispensing mechanism; an anchor station on the housing or connecting therewith; and drive means capable of moving the container seat relative to the anchor station to actuate the dispensing mechanism to energise released medicament, the drive means being actuable in response to the application of non-mechanical energy thereto, wherein gear means are provided to said drive means to gear up the torque provided thereby.

According to a further aspect of the present invention there is provided an actuator for a medicament dispenser having a medicament container and separately an aerosol container having a dispensing mechanism comprising a housing, shaped for receipt of said medicament container for containing medicament for release; an aerosol container having a dispensing mechanism; a container seat for receipt of said aerosol container having a dispensing mechanism; a dispenser seat for receipt of the dispensing mechanism; and drive means capable of moving the container seat relative to the dispenser seat to actuate the dispensing mechanism to energise released medicament, the drive means being actuable in response to the application of non-mechanical energy thereto, wherein gear means are provided to said drive means to gear up the torque provided thereby.

The actuator herein may be configured to include, as relevant, any of the above described features of the medicament dispenser. In particular, the actuator may be configured to include an electronic data management system comprising control means for the actuation of the drive means.

Preferably, the non-mechanical energy comprises electric current flow to the drive means (e.g. to an electric motor component thereof).

Suitably, the actuator additionally comprises an electronic control system for controlling the supply of non-mechanical energy to the drive means. Suitably, the electronic control system is capable of providing pulses of non-mechanical energy to the drive means.

Suitably, the electronic control system is capable of receiving inputs from electronic sensors locatable on the dispenser. Suitably, the actuator additionally comprises an electronic sensor selected from the group consisting of a breath sensor, a shake sensor, a temperature sensor, an infrared sensor and a patient ID sensor.

According to a further aspect of the present invention there is provided a laboratory test apparatus comprising at least one actuator as described above and a mounting (e.g. a bench mounting) for the at least one actuator. The laboratory test apparatus is designed for use in testing the performance of the medicament dispenser in a laboratory environment. Often, plural actuators will be mounted on a single mounting to enable simultaneous testing thereof. The laboratory test apparatus will typically be connected to various sensors and recording devices for monitoring aspects of the performance of the medicament dispenser.

According to a further aspect of the present invention there is provided a kit of parts comprising a medicament dispenser as described above in the form of a cartridge; and a housing shaped for receipt of said cartridge.

According to a further aspect of the present invention there is provided a kit of parts comprising an actuator as described above and, receivable by said actuator, a medicament container having a dispensing mechanism.

In a preferred commercial embodiment herein, the actuator is arranged for receipt of a refill cartridge. Typically, the actuator is in the form of a relatively complex device, including for example an electronic data management system and the cartridge is in the form of a medicament refill therefor.

In another aspect the cartridge comprises a medicament dispenser having a voltaic cell as an electrical energy source and the housing is provided with a mouthpiece or nozzle for patient inhalation therethrough and electronic information display apparatus for displaying information to the patient.

The invention will now be described further with reference to the accompanying drawings in which:

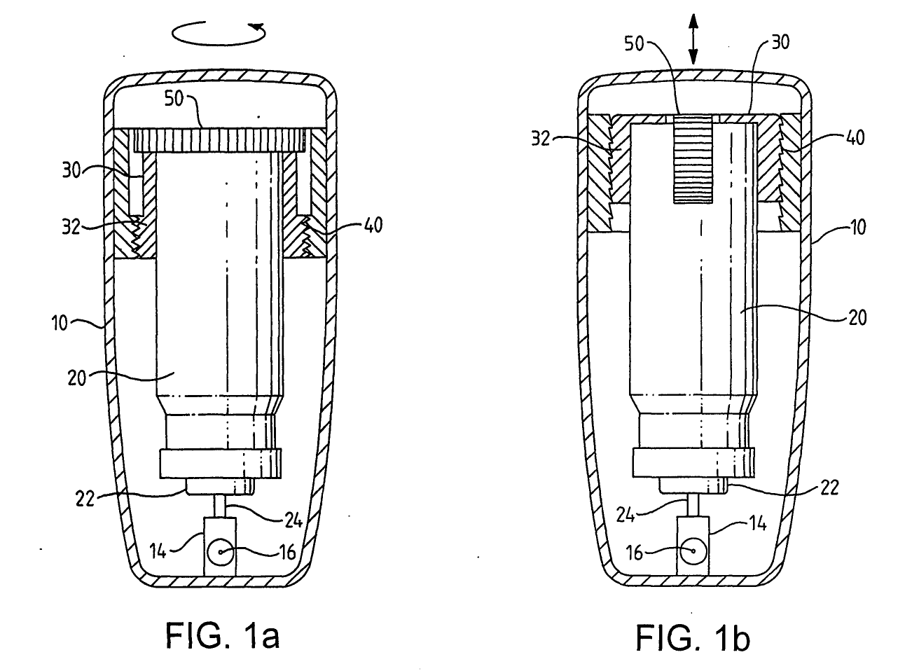

FIG. 1a is a sectional side view of a first medicament dispenser in accord with the present invention; and

FIG. 1b is a sectional side view of a minor variation of the medicament dispenser of FIG. 1a.

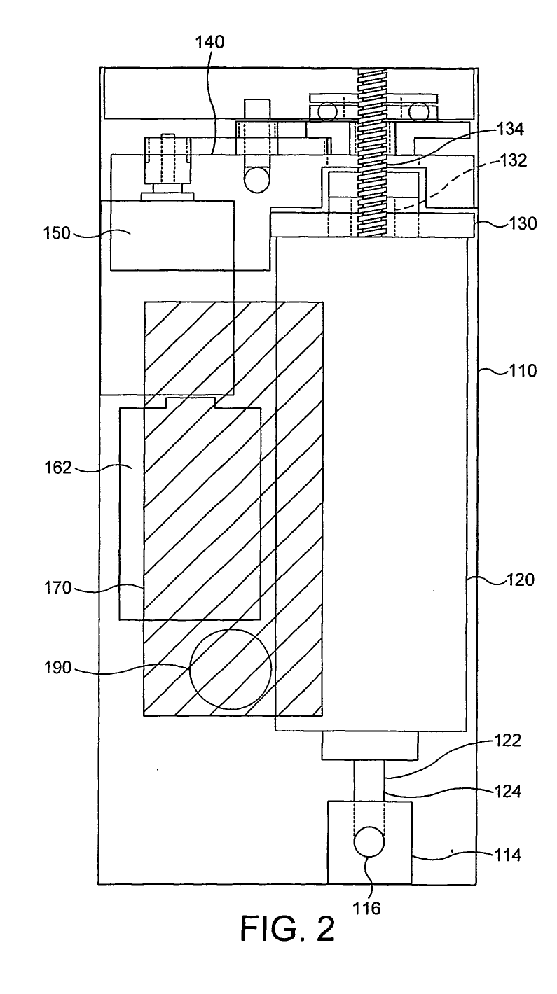

FIG. 2 is a schematic view of a second dispenser for dispensing medicament in accord with the present invention;

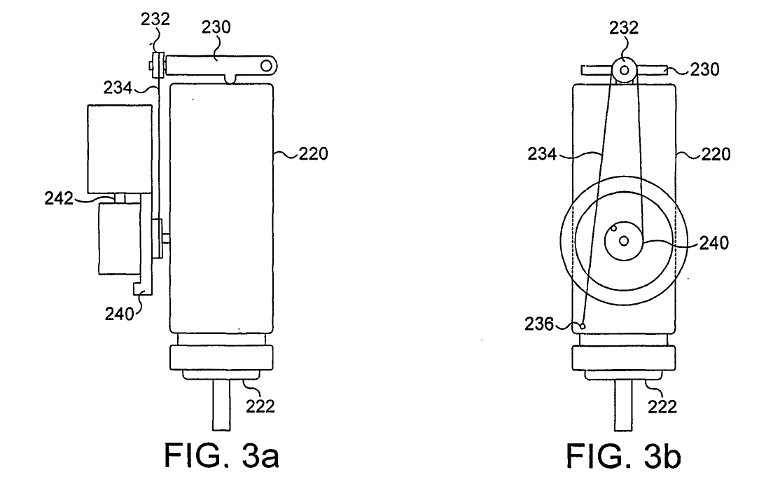

FIGS. 3a and 3b are first and second schematic views of a third dispenser for dispensing medicament in accord with the present invention;

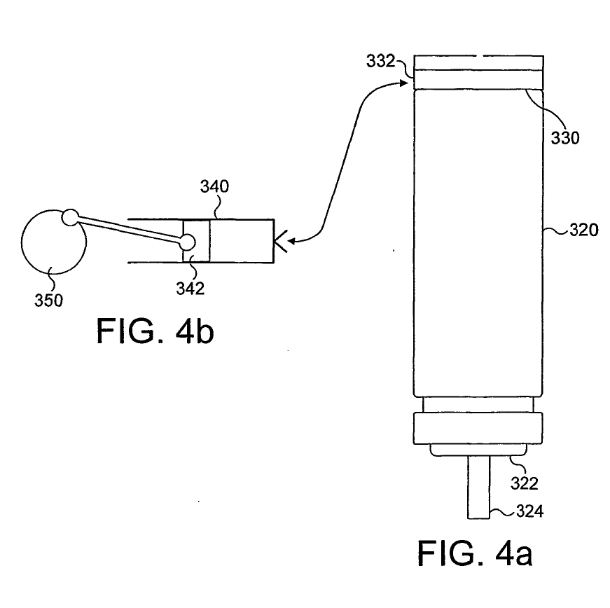

FIGS. 4a and 4b are first and second schematic views of components of a fourth medicament dispenser for dispensing medicament in accord with the present invention;

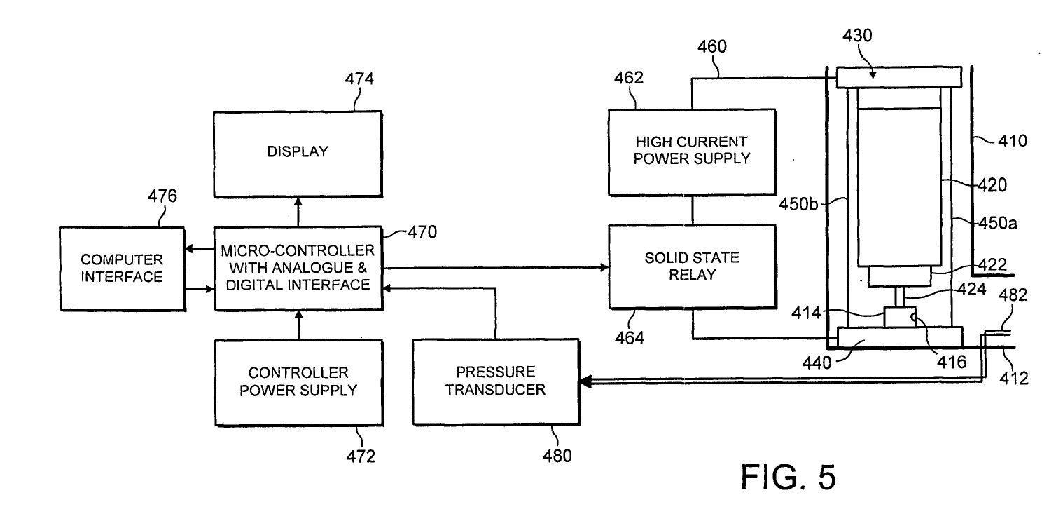

FIG. 5 is a schematic view of a first system for dispensing medicament for use herein;

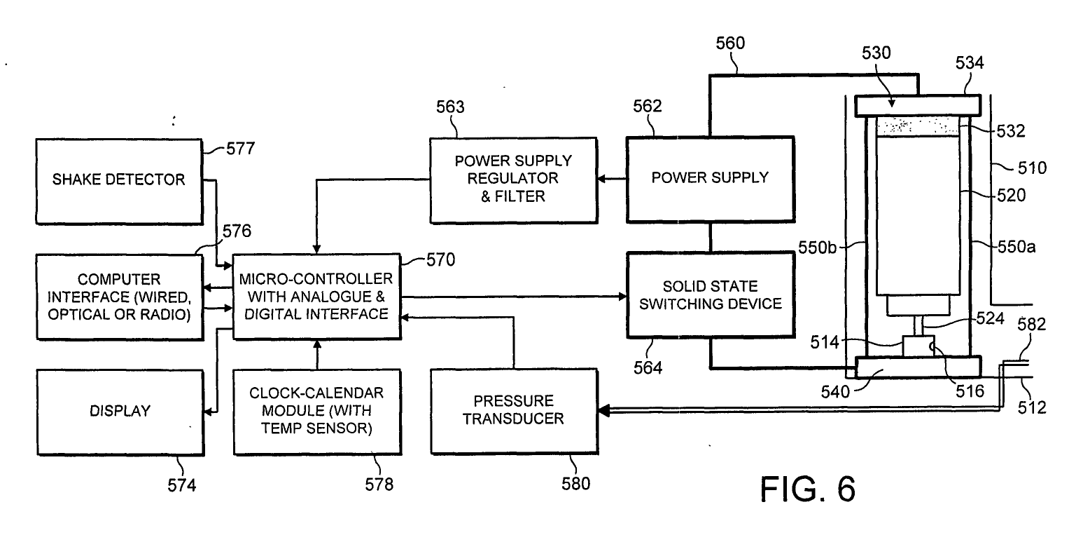

FIG. 6 is a schematic view of a second system for dispensing medicament for use herein;

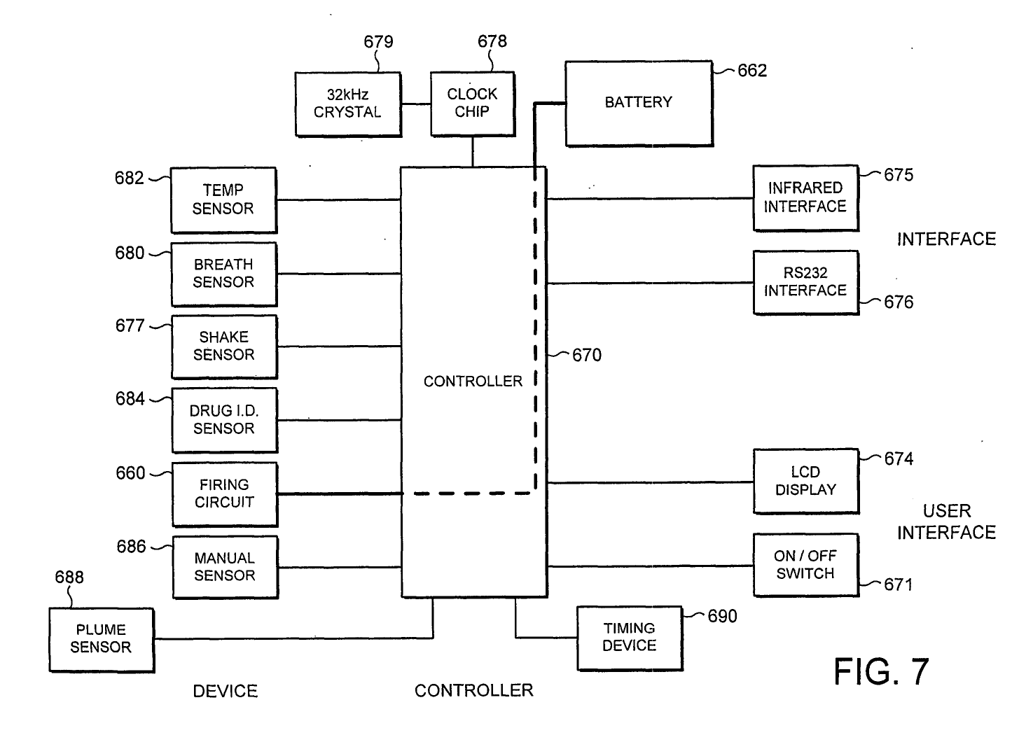

FIG. 7 is a schematic view of an electronic control system for use in accord with the present invention;

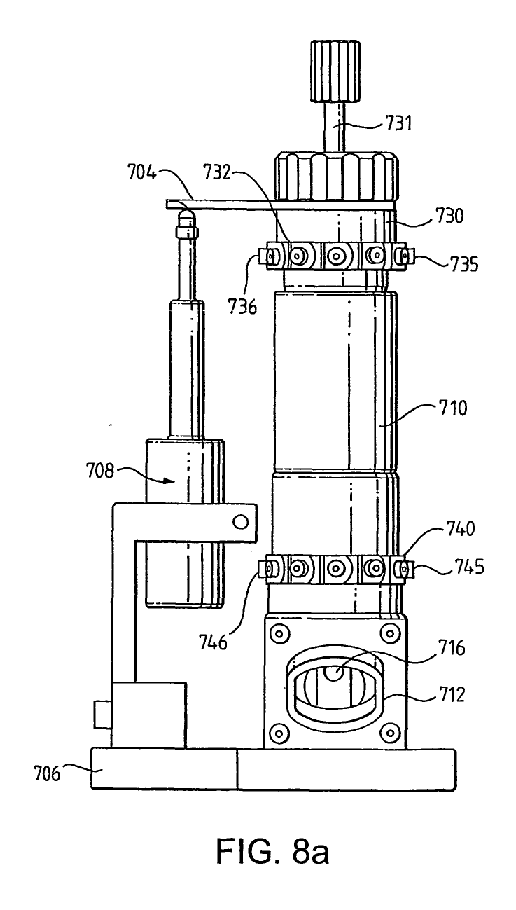

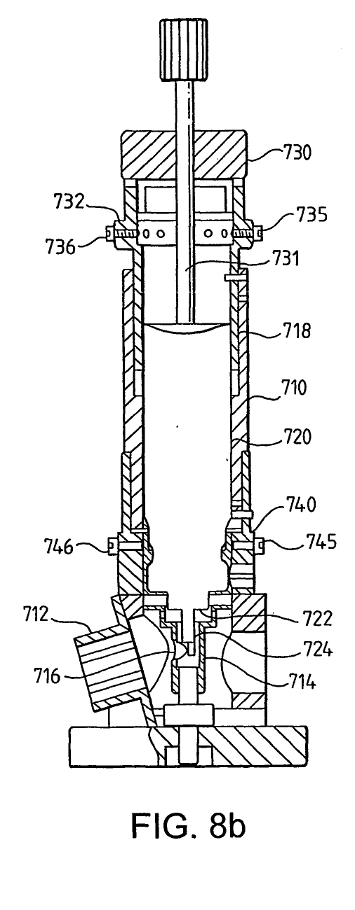

FIG. 8a is a front view of a laboratory test apparatus in accord with the present invention,

FIG. 8b is a sectional view of the laboratory test apparatus of FIG. 8a;

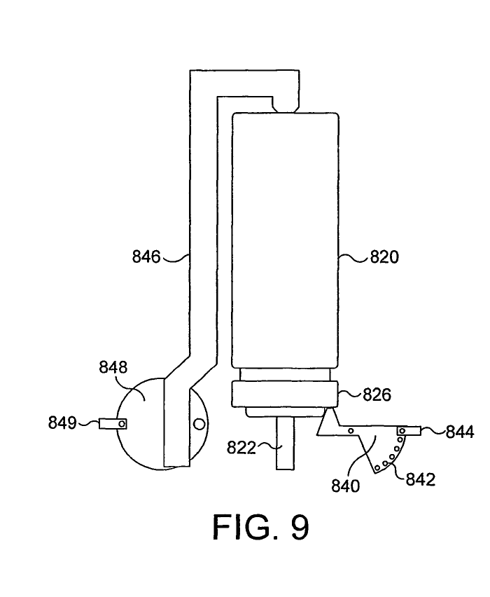

FIG. 9 is a schematic view of a first locator mechanism for use with the medicament dispenser herein;

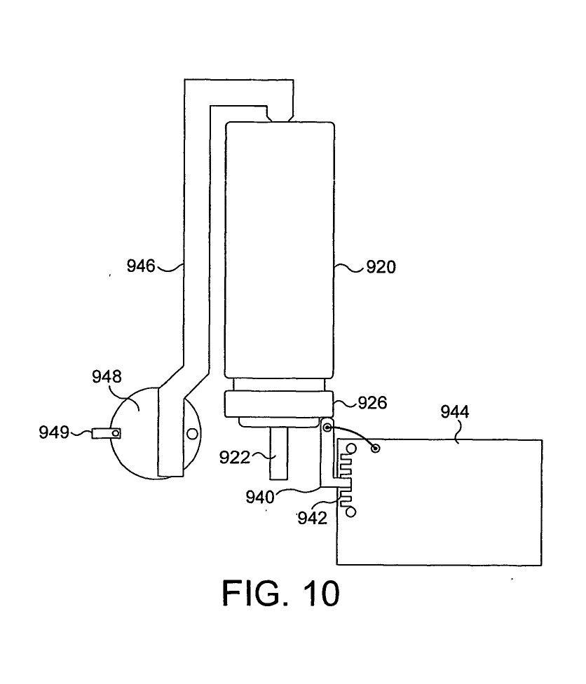

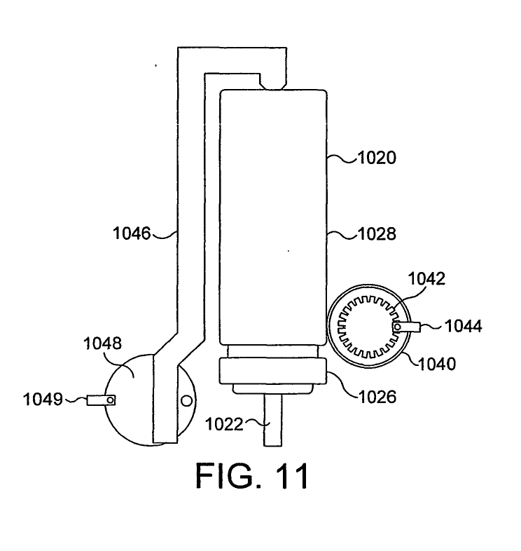

FIG. 10 is a schematic view of a second locator mechanism for use with the medicament dispenser herein;

FIG. 11 is a schematic view of a third locator mechanism for use with the medicament dispenser herein;

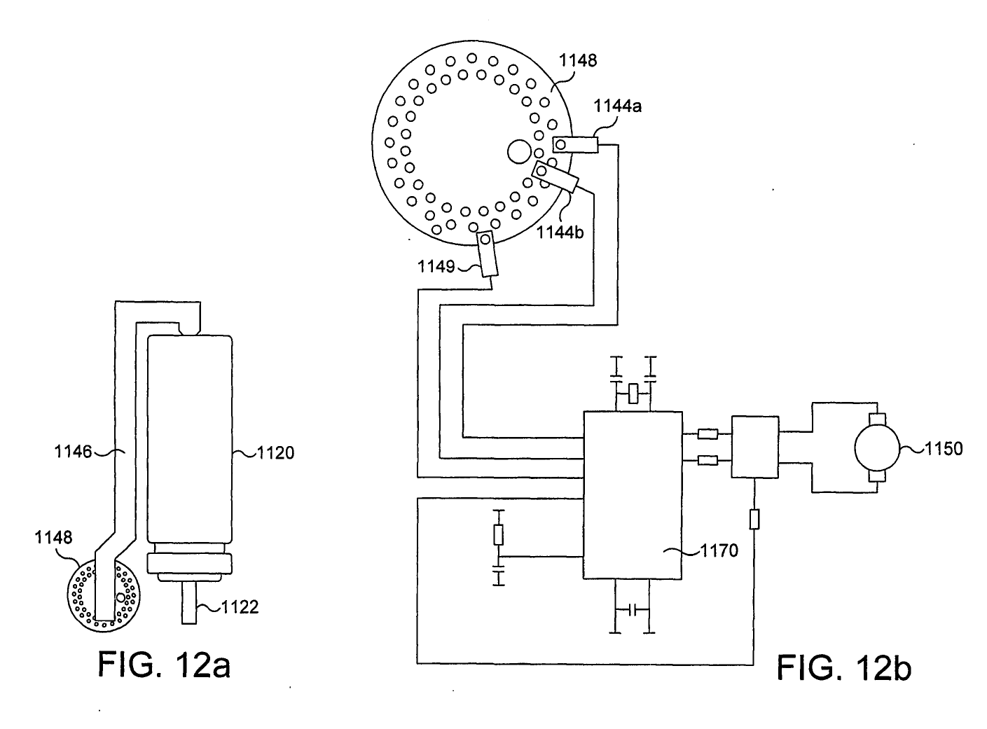

FIGS. 12a and 12b are schematic views of components of a zeroing mechanism for use with the medicament dispenser herein;

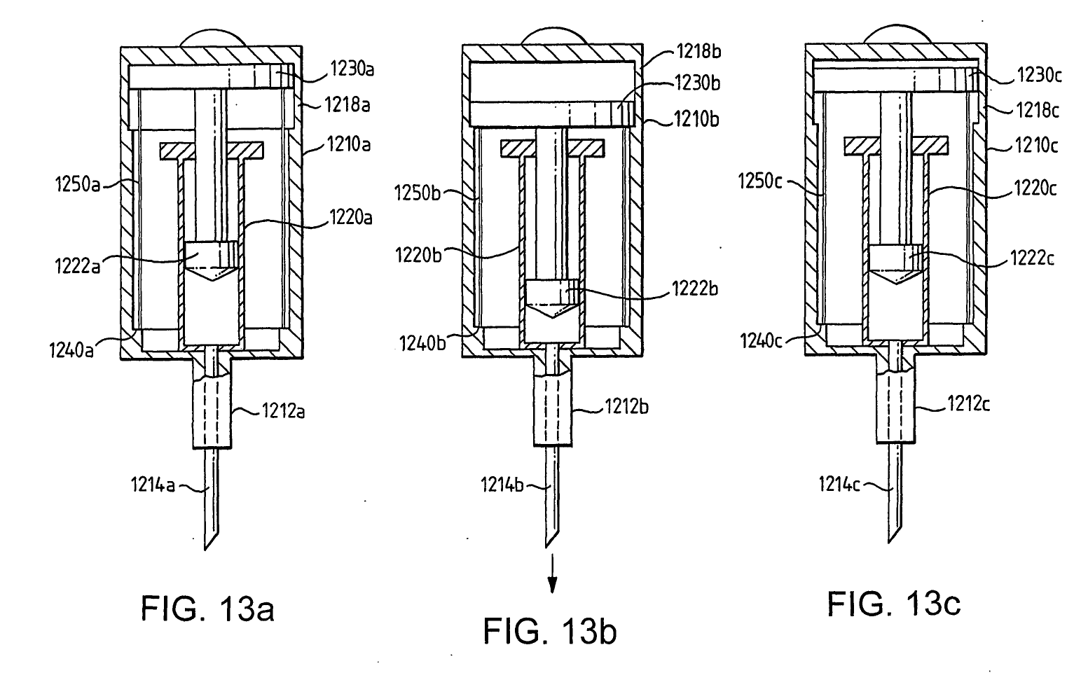

FIGS. 13a-13c are sectional views of a syringe dispenser in accord with the present invention in rest, fire and retract positions respectively;

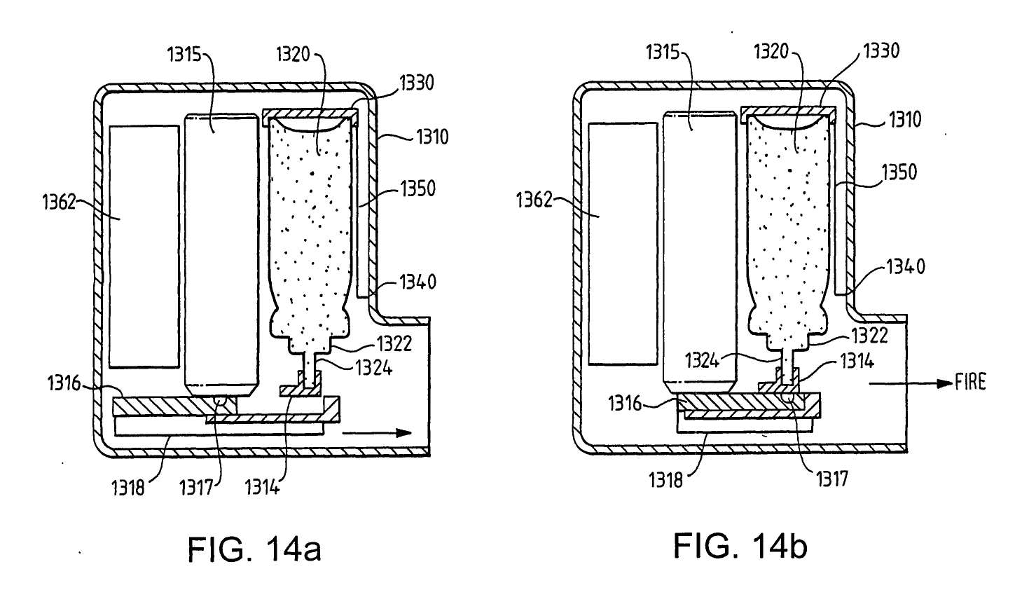

FIG. 14a shows an active DPI type medicament dispenser according to another aspect of the invention in a rest position; and

FIG. 14b shows the medicament dispenser of FIG. 14a in a ‘ready to fire’ position.

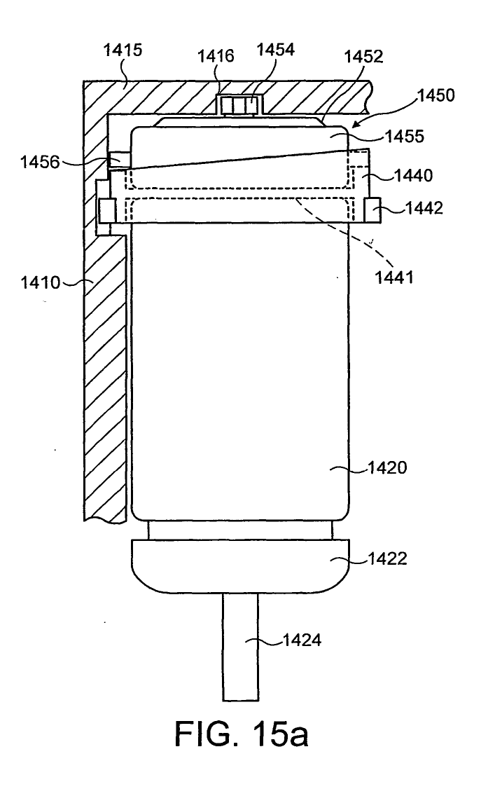

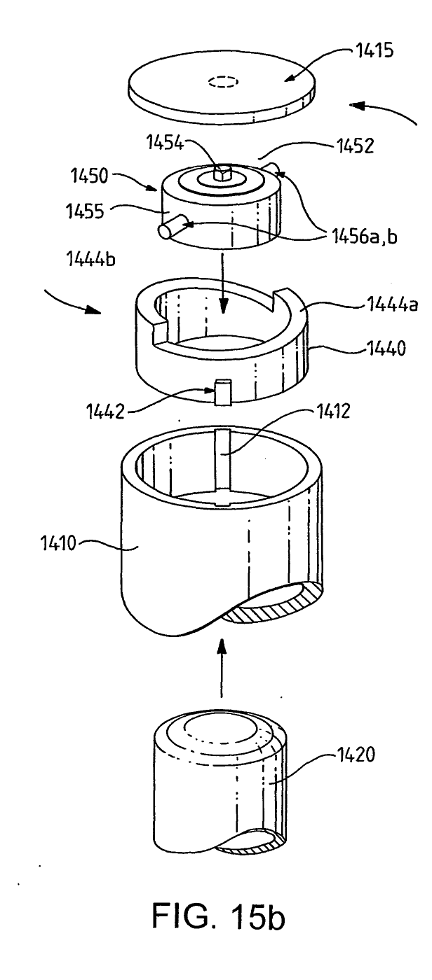

FIGS. 15a & b are schematic views of a medicament dispenser utilising an ultrasonic motor drive mechanism in accord with the present invention.

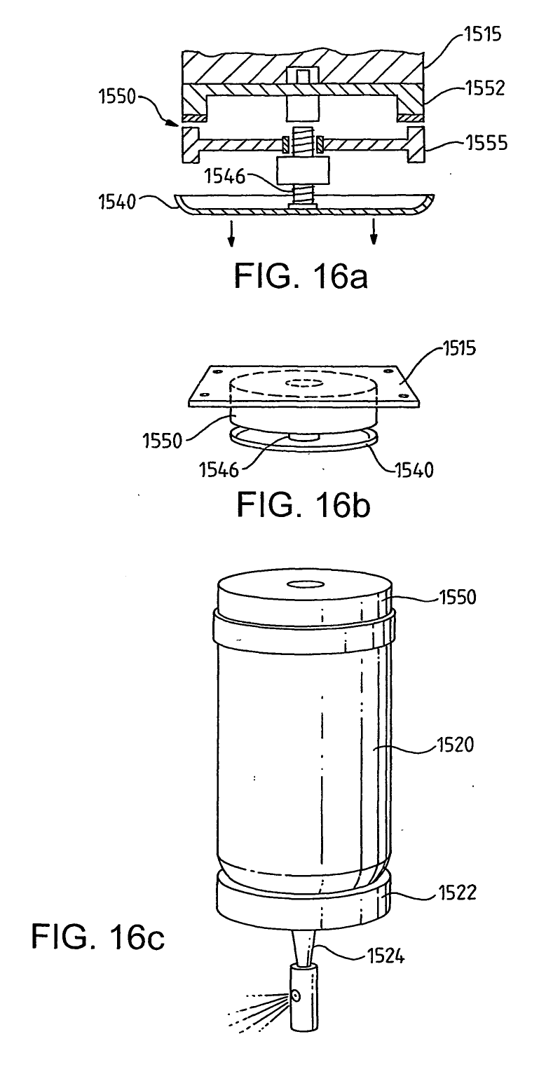

FIGS. 16a-c show the use of another ultrasonic motor drive mechanism for dispensing medicament in accord with the present invention.

FIGS. 1a and 1b show variations of a metered dose inhaler for the delivery of medicament for inhalation by a patient. The inhaler comprises a tubular housing 10 in which an aerosol container 20 is located. The aerosol container 20 has a valve dispensing mechanism 22 in the form of a slide valve. Valve stem 24 connects with a support 14. The support 14 is provided with an outlet passage 16 enabling dispensed dose to pass through to the dispensing outlet 12. It will be appreciated that dispensing of the dose requires the aerosol container 20 to be depressed to actuate the slide valve dispensing mechanism 22 and dispense medicament into the outlet 12 from which it can be inhaled by a patent.

It may be seen in FIG. 1a that the upper part of the aerosol container 20 is received by container seat 30 which is provided with a threaded gearing collar 32 shaped for screw engagement with the threaded inner surface 40 of the housing 10. Rotary PZ motor drive 50 acts such as to drive the container seat 30 in a rotary sense thereby screwing the seat 30 (through the screw engagement of collar 32 and threaded inner surface 40) and container 10 in a downwards direction. Actuation of the valve dispensing mechanism 22 and dispensing of medicament dose thereby results.

In the slight variation of FIG. 1b it may be seen that the upper part of the aerosol container 20 is also received by container seat 30 which is provided with a worm gear collar 32 shaped for engagement with the wormed inner surface 40 of inchworm Rotary PZ motor drive 50. Actuation of the drive motor 50 acts such as to drive the container seat 30 in a reciprocating linear sense thereby inching the seat 30 (through the inchworm engagement of collar 32 and inner surface 40) and container 10 in a downwards direction. Actuation of the valve dispensing mechanism 22 and dispensing of medicament dose thereby results.

FIG. 2 shows a schematic representation of a medicament dispensing system herein. The system comprises a metered dose inhaler similar to that shown in more detail in FIGS. 1a and 1b comprising tubular housing 110. Within the housing 110 sits aerosol container 120 which has a valve dispensing mechanism 122 in the form of a slide valve. Valve stem 124 is supported by valve support 114. Outlet passage 116 is provided in the support 114 to enable passage of dispensed dose to the patient.

It may be seen that the upper part of the aerosol container 120 abuts container seat 130. The container seat 130 comprises a central threaded hole 132 for receipt of worm drive shaft 134. The worm drive shaft 134 is coupled through gear mechanism 140 to DC electric motor 150 powered by battery 162. It may be appreciated that actuation of the drive motor 150 results in transfer of torque through the gear mechanism 140 and hence to the worm drive shaft 134. The worm drive shaft 134 then acts such as to push the medicament container 120 in a downwards direction resulting in the actuation of the slide valve 122. Control is provided through electronic control system 170 (shown in outline only). The travel of the medicament container 120 during an actuation operation is tracked by tracker ball 190.

FIGS. 3a and 3b show schematic representations of a medicament dispensing system herein. The system comprises a metered dose inhaler similar to that shown in more detail in FIGS. 1a and 1b comprising tubular housing (not shown) and within the housing an aerosol container 220 which has a valve dispensing mechanism 222 in the form of a slide valve. In a complete device the valve stem 224 would be supported by a valve support (not shown) having an outlet passage.

It may be seen that the upper part of the aerosol container 220 abuts pivot seat 230. The pivot seat 230 comprises a pulley wheel 232 for receipt of pulley wire 234. The pulley wire 234 is anchored at one end to anchor point 236. The pulley wire 234 couples through gearwheel mechanism 240 and worm drive 242 to DC electric motor 250. It may be appreciated that actuation of the drive motor 250 results in transfer of torque through the worm drive 242 to the gearwheel 140 and hence to the pulley wire 234. The pulley wire 234 then acts through pulley wheel 232 such as to pull down on the pivot seat 230 thereby applying downward force to the medicament container 220 resulting in the actuation of the slide valve 222. Control may be provided through an electronic control system (not shown).

FIGS. 4a and 4b show schematic representations of component parts of a medicament dispensing system herein. The system comprises a metered dose inhaler similar to that shown in more detail in FIGS. 1a and 1b comprising tubular housing (not shown) and within the housing an aerosol container 320 which has a valve dispensing mechanism 322 in the form of a slide valve. In a complete device the valve stem 324 would be supported by a valve support (not shown) having an outlet passage.

It may be seen that the upper part of the aerosol container 320 abuts the base 330 of a hydraulic chamber 332. The hydraulic chamber 332 couples through pump mechanism 340 comprising piston 342 to DC electric motor 350. It may be appreciated that rotary actuation of the drive motor 350 results in movement of the piston 342 within the pump 340 and hence to transfer of hydraulic pressure to hydraulic chamber 332 which expands thereby applying downward force to the medicament container 320 resulting in actuation of the slide valve 322. Control may be provided through an electronic control system (not shown).

FIG. 5 shows a schematic representation of a breath-operable medicament dispensing system herein. The system comprises a metered dose inhaler similar to that shown in more detail in FIGS. 1a and 1b comprising tubular housing 410 having a dispensing outlet 412 in the form of a mouthpiece. Within the housing 410 sits aerosol container 420 which has a valve dispensing mechanism 422 in the form of a slide valve. Valve stem 424 is supported by valve support 414. Outlet passage 416 is provided in the support 414 to enable passage of dispensed dose to the dispensing outlet 412.

It may be seen that the upper part of the aerosol container 420 abuts container seat 430 which in turn directly contacts the aerosol container 420. It may also be seen that the valve support 414 connects with valve seat 440. Plural wires 450a, 450b connect the container seat 430 to the valve seat 440. The wires 150a, 150b form part of a motorised pulley system (like that shown in FIGS. 3a and 3b). It may thus, be appreciated that on actuation of the motorised pulley system the container seat 430 and valve seat 440 will be drawn towards each other. Actuaton of the valve dispensing mechanism 422 and dispensing of medicament dose will thereby result.

Control of electrical current flow to motorised pulley system is achieved using the illustrated circuitry (shown schematically). Actuation circuit 460 includes a high current power supply 462 (e.g. a voltaic cell or battery of voltaic cells) and a switch 464 in the form of a solid state relay. The solid state relay 464 itself connects with control circuitry including a micro-controller 470 having an independent power supply 472. The micro-controller 470 itself connects with pressure transducer 480 which has an input in the form of a pressure tube 482 located within the dispensing outlet 412 of the inhaler housing 410.

It may be appreciated that actuation of the motorised drive system, and hence actuation of the valve dispensing mechanism may be achievable as follows. The patient inhales through the mouthpiece 412 resulting in a change in pressure within the housing 410 and pressure tube 482. The change in pressure is detected by the pressure transducer 480 which sends a signal to the micro-controller 470. The micro-controller 470, in turn sends a switching signal to the solid state relay 464 which results in closing of the actuation circuit and electrical current flow therethrough. The resulting actuation of the drive mechanism causes actuation of the valve dispensing mechanism 422 and hence, dispensing of medicament to the inhaling patient.

It may also be seen in FIG. 5 that the micro-controller 470 is connected to a display 474 for display of information to the patient and also with a computer interface 476 for exchange of data therewith. All circuitry and components thereof including the power supplies 462, 472 and display 474 may be arranged to be present on the housing 410 such that the system is in the form of a discrete, hand-held device.

FIG. 6 shows a schematic representation of a breath-operable medicament dispensing system herein. The system comprises a metered dose inhaler similar to that shown in more detail in FIGS. 1a and 1b comprising tubular housing 510 having a dispensing outlet 512 in the form of a mouthpiece. Within the housing 510 sits aerosol container 520 which has a valve dispensing mechanism 522 in the form of a slide valve. Valve stem 524 is supported by valve support 514. Outlet passage 516 is provided in the support 514 to enable passage of dispensed dose to the dispensing outlet 512.

It may be seen that the upper part of the aerosol container 520 abuts container seat 530 which directly contacts the aerosol container 520. It may also be seen that the valve support 514 connects with valve seat 540. Plural wires 550a, 550b connect the container seat 530 to the valve seat 540. The wires 550a, 550b form part of a motorised pulley system (like that shown in FIGS. 3a and 3b). It may thus, be appreciated that on actuation of the motorised pulley system the container seat 530 and valve seat 540 will be drawn towards each other. Actuation of the valve dispensing mechanism 522 and dispensing of medicament dose will thereby result.

Control of electrical current flow to the drive system is achievable using the illustrated circuitry (shown in schematic form). Actuation circuit 560 includes a power supply 562 (e.g. a voltaic cell or battery of voltaic cells) and a switch 564 in the form of a solid state switching device. The switch 564 itself connects to control circuitry including micro-controller 570 which has an analogue and digital interface. The power supply for the control circuitry is taken from the power supply 562 for the drive after suitable regulation and filtering 563. The micro-controller 570 itself connects with pressure transducer 580 which has an input in the form of a pressure tube 582 located within the dispensing outlet 512 of the inhaler housing 510.

It may be appreciated that current flow to the drive mechanism, and hence actuation of the valve dispensing mechanism 522 may be achievable as follows. The patient inhales through the mouthpiece 512 resulting in a change in pressure within the housing 510 and pressure tube 582. The change in pressure is detected by the pressure transducer 580 which sends a signal to the micro-controller 570. The micro-controller 570, in turn sends a switching signal to the solid state switching device 564 which results in closing of the actuation circuit and electrical current flow therethrough. The resulting actuation of the drive system causes actuation of the valve dispensing mechanism 522 and hence, dispensing of medicament to the inhaling patient.

It may also be seen in FIG. 6 that the micro-controller 570 is connected to a display 574 for display of information to the patient and also with a computer interface 576 for exchange of data therewith. Communication with the computer interface 576 may be via a wired, optical or radio communications link. The micro-controller 570 is also connected to shake detector 577 for use in detecting whether the container 520 is shaken prior to actuation of the valve dispensing mechanism 522 and to a clock-calendar module 578 including a temperature sensor. All circuitry and components thereof including the power suppy 562, display 574, shake detector 577, computer interface 576 and clock-calendar module 578 may be arranged to be present on the housing 510 such that the system is in the form of a discrete, hand-held device.

FIG. 7 shows a schematic representation of electronic components for use in a dispenser herein and an electronic control system therefor. The control system is essentially a more sophisticated version of the system shown in FIGS. 5 and 6 and is suitable, in aspects for use in controlling the medicament dispensers herein. Central controller 670 receives inputs and/or transmits outputs to each of the respective components. Key components associated with the central controller are clock chip 678 and 32 KHz crystal 679 and a power supply 662 in the form of a battery. A suitable battery 662 delivers 6 Volts and has a capacity of 1.3 Amp Hours and is capable of supplying 4.5 Amps. The central controller 670 communicates with various sensors on the device including a temperature sensor 682 for sensing ambient temperature; a breath sensor 680 (e.g. in the form of a pressure transducer) for sensing the breath of a patient; a shake sensor 677 for detecting shaking of the device; a Drug ID sensor 684 for reading information from a transceiver on a medicament container to check drug identity and integrity; a manual sensor 686 (e.g. in the form of a switch) for detecting manual actuation of the device; a plume sensor 688 (e.g. in the form an infra red emitter/detector) for detecting firing from the medicament container.

System clock 690 (e.g. in the form of a crystal or ceramic resonator) enables control over the supply of electrical current to the firing circuit 660. User interface features comprising an on/off switch 671 and LCD display 674 also communicate with the central controller 670. External communications interfaces comprising an RS232 interface 676 and infra red interface 675 for data transfer to a docking station or printer are also provided.

It will be appreciated that each of the components of the control system may perform an independent function, or that the action of components may be combined to facilitate the working of the system as a whole. An example of a combination action would be sensing of a patient's inhalation by the breath sensor 680; communication of that breath sensing to the controller 670; communication from the controller 670 to the timing device 690 which controls electrical current flow to the firing circuit 660; the resulting firing of the drug dispenser by; sensing of that firing by the plume sensor 688; and a ‘firing complete’ message displayed to the patient at the LCD Display 674.

FIGS. 8a and 8b show a laboratory test apparatus for use in the testing of an aerosol container having a valve dispensing mechanism such as may be used in a standard metered dose inhaler. The test apparatus comprises a tubular housing 710 in which an aerosol container 720 is located. The housing is mounted on solid base 706 to enable ready placement on a laboratory bench surface. A dispensing outlet 712 leads laterally from the closed end of the housing 710. In the embodiment illustrated, the outlet 712 has a form similar to that of a mouthpiece as would be found on a standard metered dose inhaler.

The aerosol container 720 has a valve dispensing mechanism 722 in the form of a slide valve. Valve stem 724 connects with a support 714. The support 714 is provided with an outlet passage 716 enabling dispensed dose to pass through to the dispensing outlet 712. It will be appreciated that dispensing of the dose requires the aerosol container 720 to be depressed to actuate the slide valve dispensing mechanism 722 and dispense medicament into the outlet 712.

It may be seen that the upper part of the aerosol container 720 abuts variable tension screw 731 which forms part of container seat 730. The container seat 730 is received within the housing 710 within track 718 cut into the wall of the housing 710. The container seat 730 is provided with a collar 732 comprising a number of wire attachment points 735, 736 (for clarity, not all attachment points are labelled). The lower end of the housing 710 is provided with a similar collar 740 also comprising a number of wire attachment points 745, 746 (again for clarity, not all attachment points are labelled). The collars 732, 740 are arranged to enable the attachment of plural lengths of pulley wire (not shown) to connect the respective wire attachment points 735, 736 and 745, 746 in a pulley arrangement. The pulley is driven by an electric DC motor (not shown). It may thus, be appreciated that when the pulley system is actuated the collars 732, 740 and hence the container seat 730 and housing 710 will be drawn towards each other by the action of the pulley system. Actuation of the valve dispensing mechanism 722 and dispensing of medicament dose will thereby result.

The container seat 730 is coupled through coupling arm 704 to linear displacement transducer 708 (e.g. a linear variable differential transformer) which detects the displacement of the container 720 on actuation. Various other parts of the laboratory test apparatus may optionally be connected to other sensors for monitoring all aspects of the dispensing process. The sensors may comprise any suitable sensor types including optical, electrical and pressure sensors. The sensors may themselves be connected to various electronic recording and data management systems.

FIG. 9 shows a locator system for use with the medicament dispenser herein. Conventional MDI aerosol can 820 has a valve dispensing mechanism 822 in the form of a slide valve and a crimped neck 826. Can follower mechanism 840 in the form of a sprung lever abuts the neck of the can and comprises graduations 842 which are readable by position sensor 844. As the can 820 moves it may be appreciated that the can follower 840 will follows its movement. The movement of the follower 840 will in turn be sensed by the sensor 844. Zeroing mechanism in the form of a crank shaft 846 and wheel 848 detects the zero position of the can (i.e. before movement) via zero sensor 849. In use, it may therefore be appreciated that both the zero position of the can 820 and its movement through a drive stroke and return may be monitored. The sensors 844, 849 will in general communicate with an electronic control system (not shown) which also controls the input of power to the drive mechanism (also not shown).

FIG. 10 shows an alternative locator system for use with the medicament dispenser herein. Conventional MDI aerosol can 920 has a valve dispensing mechanism 922 in the form of a slide valve and a crimped neck 926. Can follower mechanism 940 in the form of a sprung loaded wiper abuts the neck of the can. The wiper comprises electrically conductive material and is arranged to contact variable resistor track 942 on printed circuit board 944 thereby forming a circuit. As the can 920 moves it may be appreciated that the sprung wiper 940 will also move and that the movement of the wiper 940 along the variable resistor track 942 may be sensed by the voltage change arising from the variation of resistance in the circuit. Zeroing mechanism in the form of a crank shaft 946 and wheel 948 detects the zero position of the can (i.e. before movement) via zero sensor 949. In use, it may therefore be appreciated that both the zero position of the can 920 and its movement through a drive stroke

and return may be monitored. The circuit board 944 and sensor 949 will in general communicate with an electronic control system (not shown) which also controls the input of power to the drive mechanism (also not shown).

FIG. 11 shows a further locator system for use with the medicament dispenser herein. Conventional MDI aerosol can 1020 has a valve dispensing mechanism 1022 in the form of a slide valve; a crimped neck 1026; and side wall 1028. Can follower mechanism 1040 in the form of a ‘soft tyre’ mouse wheel contacts the side wall 1028 of the can and comprises regular markings 1042 which are readable by position sensor 1044. As the can 1020 moves it may be appreciated that the mouse wheel 1040 will follow its movement and that the movement of the mouse wheel 1040 will be sensed by the sensor 1044. Zeroing mechanism in the form of a crank shaft 1046 and wheel 1048 detects the zero position of the can (i.e. before movement) via zero sensor 1049. In use, it may therefore be appreciated that both the zero position of the can 1020 and its movement through a drive stroke and return may be monitored. The sensors 1044, 1049 will in general communicate with an electronic control system (not shown) which also controls the input of power to the drive mechanism (also not shown).

FIGS. 12a and 12b show components of a zeroing and drive system for use with an MDI aerosol can 1120 having a valve dispensing mechanism 1122 in the form of a slide valve. Crank handle 1146 and wheel 1148 detect the zero position of the can (i.e. before movement) via zero sensor 1149. The wheel 1148 is drivable by drive motor 1150 (shown in FIG. 12a only) to move the crank shaft 1146 and thereby depress the can 1120 resulting in firing thereof. The zero sensor 1149; drive motor 1150; and position sensors 1144a, 1144b connect through circuitry to microcontroller 1170. A typical use profile will therefore comprise sensing of the zero position of the can via use of the wheel 1148 and zero sensor 1149; actuation of the motor 1150 to drive the crank wheel 1148 and crank shaft 1146 resulting in depression and firing of the can 1120; sensing of the position of the can 1120 throughout the actuation stroke via position sensors 1144a, 1144b; detection of a stroke maximum by the position sensors 1144a, 1144b followed by reversal of the motor drive 1150 and return of the wheel 1148 and can 1120 to the zero position.

FIGS. 13a, 13b and 13c show schematic representations of a syringe for the delivery of medicament by injection in the rest, fire and retract positions respectively. The syringe comprises a hollow tubular barrel housing 1210a-c defining a medicament chamber 1220a-c. A dispensing outlet 1212a-c leads laterally from the closed end of the chamber 1220a-c. Connecting to outlet 1212a-c there is provided hollow needle 1214a-c through which medicament is dispensed.

The medicament chamber 1220a-c has a drug dispenser mechanism 1222a-c in the form of a plunger rod. The plunger rod 1222a-c is movable within the chamber 1220a-c to vary the volume thereof and hence, to expel any medicament preparation contained therein (generally in solution form) through the outlet 1212a-c to the hollow needle 1214a-c. It will thus, be appreciated that dispensing of the medicament requires the plunger 1222a-c to be depressed to dispense medicament into the outlet 1212a-c and thence to the hollow needle 1214a-c through which it is injectable through the skin of a patient.

It may be seen that the upper part 1224a-c of the plunger 1222a-c is received by actuator seat 1230a-c. The actuator seat 1230a-c is slidably movable within the housing 1210a-c along track 1218a-c cut it into the wall of the housing 1210a-c. Drive wire 1250a-c connects actuator seat 1230a-c to a fixed anchor position 1240a-c at the base of the housing 1210a-c. The wire 1250a-c is drivable through a pulley system (as shown in FIGS. 3a and 3b). It may thus, be appreciated that when the pulley system is actuated the actuator seat 1230a-c and hence the plunger 1222a-c will be drawn down towards the fixed anchor position 1240a-c by the action of the wire. Actuation of the plunger dispensing mechanism 1222a-c and dispensing of the medicament through the outlet 1212a-c and hollow needle 1214a-c will thereby result.

FIGS. 14a and 14b illustrate an active dry powder reservoir inhaler herein. The inhaler housing 1310 comprises a powder metering and transport system comprising a powder reservoir 1315, a metered dose plate 1316 having a metering cup 1317 and a transport coupling in the form of a drive wire assembly 1318.

The inhaler housing 1310 further comprises an aerosolisation system comprising an aerosol container 1320 having a valve dispensing mechanism 1322 in the form of a slide valve. The aerosol container 1320 comprises a liquefied gas such as liquefied air or carbon dioxide. Valve stem 1324 connects with aerosolisation block 1314. It may be seen that in the dispensing position (FIG. 14b), the block 1314 communicates with the metering cup 1317 such that when a ‘puff’ of air of gas is released from the aerosol container 1320 it will act to aerosolise a metered powder dose in the metering cup 1317. It may be seen that the upper part of the aerosol container 1320 is received by container seat 1330. The container seat 1330 is slidably movable within the housing 1310. A second length of drive wire 1350 connects the container seat 1330 to an anchor position 1340 on the inhaler housing. The wire 1350 is drivable by a motorised pulley system.

The inhaler is breath operated such that as the patient inhales the power supply 1362 (as controlled by an electronic control system, not shown) actuates drive wire assembly 1318 which draws the metered dose plate 1316 containing a metered dose in the metering cup 1317 thereof away from the powder reservoir 1315 to the aerosolisation block 1324 for aerosolisation. The second drive wire 1350 is then actuated such as to draw the container seat 1330 towards the anchor position 1340. Actuation of the valve dispensing mechanism 1322 and aerosolisation of the powder medicament dose thereby results.

FIGS. 15a and b illustrate another means for actuating the valve dispensing mechanism by use of a ‘lamellar’ ultrasonic motor. In the schematic sectional perspective shown in FIG. 15a an aerosol container 1420 is located in a tubular housing 1410 with one end (referred hereinafter as ‘the upper’ end) of the container in contact with the base or membrane 1441 of a cam gear 1420. The opposite or ‘lower’ end of the container 1420 comprises a valve dispensing mechanism 1422 and a valve stem 1424. An ultrasonic rotary motor 1450 is attached to the housing cover 1415 by a fixture 1454, located in cover recess 1416, and comprises a stator 1452 and rotator 1455. When energised by a suitable power source such as a battery, rotation of the rotor 1455 and lugs 1456 causes vertical displacement of the cam gear 1440 such that membrane 1441 forces container 1420 in a vertical direction, thus actuating the valve dispensing mechanism 1422 and dispensing a dose of medicament from valve stem 1424.

FIG. 15b is an exploded schematic diagram illustrating the component parts of the drive mechanism and the arrangement of the cam 1440 in the housing 1410. The ultrasonic motor 1450 is normally enclosed in housing 1410 and secured to cover 1415 by fixture 1454. When energised, the stator 1452 causes the rotor 1455 to rotate in the direction of the arrow such that pegs 1456a,b climb the cam gear ramps 1444a-b and in so doing push the cam 1440 in a linear direction towards the container 1420. The cam 1440 is prevented from rotating by keys 1442 which are located in the housing channel 1412. The pegs 1456 will continue to push the cam 1440 towards the container 1420 until they reach the top of each ramp 1444a-b, representing the maximum linear displacement of the cam, and then move to a position at the bottom of the next respective ramp. Thus the maximum displacement of the cam 1440 is determined by the distance between the base and top of the ramps 1444a-b. In this way, the container 1420 is depressed by the cam membrane (not shown) at the base of the cam 1440 to actuate the valve dispensing mechanism and release a medicament dose. At the end of the power stroke the container 1420 and cam 1440 are returned to their resting positions by the action of the spring in the valve mechanism (not shown). It should be understood that alternative return mechanisms, utilising a resilient spring mechanism other than that in the canister valve, could be used.

Another embodiment illustrating the use of a drive mechanism incorporating a ‘ring’ ultrasonic motor is shown in FIGS. 16a-c. The key components of the drive mechanism are the ultrasonic motor 1550, comprising stator 1552 and rotor 1555, jacking plate 1540 and screw drive 1546 (FIG. 16a). The motor 1550 is normally fixed to a housing cover 1515. When powered by, for example, a battery, the stator 1552 will cause the rotor 1555 to rotate and with it screw drive 1546. Depending upon the direction of rotation, jacking platform 1540 will be lowered to depress an aerosol container located below and actuate the valve dispensing mechanism 1522 to release a medicament dose. Reversing the direction of rotation of screw drive 1546 raises the jacking plate 1540 once more into the resting position, where it exerts no pressure on the aerosol container.

FIG. 16b shows the ultrasonic motor 1540, attached to housing cover 1515, in communication with jacking plate 1540 through screw drive 1546. As will be seen from FIG. 16c the motor 1550 and jacking plate 1540 are positioned at the top of aerosol container 1520 such that depression of the plate 1540 actuates the dispensing mechanism 1522 to release a dose of medicament through valve stem 1524.

It will be understood that other types of ultrasonic motors, in particular those which represent a ‘hybrid’ between the ‘lamellar’ and ‘ring’ US motors, can be used as a drive mechanism.

In alternative embodiments, the powder metering and transport system and the aerosolisation system may be actuable through a coupled drive wire assembly.

For example, the drive wire assembly may sequentially actuate metering, transport and aerosolisation.

It may be appreciated that any of the parts of the dispenser or actuator which contact the medicament suspension may be coated with materials such as fluoropolymer materials (e.g. PTFE or FEP) which reduce the tendency of medicament to adhere thereto. Any movable parts may also have coatings applied thereto which enhance their desired movement characteristics. Frictional coatings may therefore be applied to enhance frictional contact and lubricants (e.g. silicone oil) used to reduce frictional contact as necessary.

The medicament dispenser of the invention is suitable for dispensing medicament, particularly for the treatment of respiratory disorders such as asthma and chronic obstructive pulmonary disease (COPD).

Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (eg as the sodium salt), ketotifen or nedocromil (eg as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (eg as the dipropionate ester), fluticasone (eg as the propionate ester), flunisolide, budesonide, rofleponide, mometasone (eg as the furoate ester), ciclesonide, triamcinolone (eg as the acetonide), 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester or 6α, 9α-Difluoro-17α-[(2-furanylcarbonyl)oxy]-11β-hydroxy-16α-methyl-3-oxo-androsta-1,4-diene-17β-carbothioic acid S-fluoromethyl ester; antitussives, e.g., noscapine; bronchodilators, e.g., albuterol (eg as free base or sulphate), salmeterol (eg as xinafoate), ephedrine, adrenaline, fenoterol (eg as hydrobromide), formoterol (eg as fumarate), isoprenaline, metaproterenol, phenylephrine, phenylpropanolamine, pirbuterol (eg as acetate), reproterol (eg as hydrochloride), rimiterol, terbutaline (eg as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; PDE4 inhibitors eg cilomilast or roflumilast; leukotriene antagonists eg montelukast, pranlukast and zafirlukast; adenosine 2a agonists, e.g. 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g. as maleate); α₄ integrin inhibitors e.g. (2S)-3-[4-({[4-(aminocarbonyl)-1-piperidinyl]carbonyloxy}phenyl]-2-[((2S)-4-methyl-2-{[2-(2-methylphenoxy)acetyl]amino}pentanoyl)amino]propanoic acid (e.g. as free acid or potassium salt), diuretics, e.g., amiloride; anticholinergics, e.g., ipratropium (eg as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagons. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament.

In aspects, preferred medicaments are selected from albuterol, salmeterol, fluticasone propionate and beclomethasone dipropionate and salts or solvates thereof, e.g., the sulphate of albuterol and the xinafoate of salmeterol.

Medicaments can also be delivered in combinations. Preferred formulations containing combinations of active ingredients contain salbutamol (e.g., as the free base or the sulphate salt) or salmeterol (e.g., as the xinafoate salt) or formoterol (eg as the fumarate salt) in combination with an antiinflammatory steroid such as a beclomethasone ester (e.g., the dipropionate) or a fluticasone ester (e.g., the propionate) or budesonide. A particularly preferred combination is a combination of fluticasone propionate and salmeterol, or a salt thereof (particularly the xinafoate salt). A further combination of particular interest is budesonide and formoterol (e.g. as the fumarate salt).

It will be understood that the present disclosure is for the purpose of illustration only and the invention extends to modifications, variations and improvements thereto.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A medicament dispenser comprising
a housing;
a medicament container having a dispensing mechanism;
a container seat for receipt of the container;
an anchor station on the housing or connecting therewith; and
drive means capable of moving the container seat relative to the anchor station to actuate the dispensing mechanism, the drive means being actuable in response to the application of non-mechanical energy thereto,
wherein gear means are provided to said drive means to gear up the torque provided thereby.

2. A medicament dispenser comprising
a medicament container having a dispensing mechanism;
a container seat for receipt of the container;
a dispenser seat for receipt of the dispensing mechanism; and
drive means capable of moving the container seat relative to the dispenser seat to actuate the dispensing mechanism, the drive means being actuable in response to the application of non-mechanical energy thereto,
wherein gear means are provided to said drive means to gear up the torque provided thereby.

3. A medicament dispenser comprising
a housing;
a medicament container for containing medicament for release;
an aerosol container having a dispensing mechanism;
a container seat for receipt of the aerosol container;
an anchor station on the housing or connecting therewith; and
drive means capable of moving the container seat relative to the anchor station to actuate the dispensing mechanism to energise released medicament, the drive means being actuable in response to the application of non-mechanical energy thereto,
wherein gear means are provided to said drive means to gear up the torque provided thereby.

4. A medicament dispenser comprising
a medicament container for containing medicament for release;
an aerosol container having a dispensing mechanism;
a container seat for receipt of the container;
drive means capable of moving the container seat relative to the dispenser seat to actuate the dispensing mechanism to energise released medicament, the drive means being actuable in response to the application of non-mechanical energy thereto,
wherein gear means are provided to said drive means to gear up the torque provided thereby.

5. A medicament dispenser according to any of claims 1 to 4, wherein the dispensing mechanism is selected from the group consisting of a valve, pump or plunger mechanism.

6. A medicament dispenser according to any of claims 1 to 5, wherein the dispensing mechanism comprises a metering mechanism.

7. A medicament dispenser according to any of claims 1 to 6, additionally comprising a reset mechanism for resetting the dispensing mechanism after actuation thereof.

8. A medicament dispenser according to claim 7, wherein the reset mechanism forms part of the dispensing mechanism.

9. A medicament dispenser according to claim 7, wherein the reset mechanism forms part of the drive means.

10. A medicament dispenser according to any of claims 1 to 9, wherein the drive means is actuable in response to the application of electrical current energy, electrical field energy or magnetic field energy thereto.

11. A medicament dispenser according to any of claims 1 to 10, wherein the drive means has a powered return action.

12. A medicament dispenser according to any of claims 1 to 10, wherein the drive means has an unpowered return action.

13. A medicament dispenser according to any of claims 1 to 12, wherein the drive means comprises an electrically-powered motor.

14. A medicament dispenser according to claim 13, wherein the motor provides linear or rotary drive.

15. A medicament dispenser according to either of claims 13 or 14, wherein the drive means comprises a motor selected from the group consisting of a DC electric motor, an AC electric motor, a piezoelectric (PZ) motor or an ultrasonic (US) motor, a solenoid motor and a linear electric motor.

16. A medicament dispenser according to any of claims 1 to 12, wherein the drive means comprises a fluid pump.

17. A medicament dispenser according to any of claims 1 to 16, wherein the drive means comprises a servo system.

18. A medicament dispenser according to claim 17, wherein said servo system comprises a controller, an amplifier and a feedback device.

19. A medicament dispenser according to claim 18, wherein said controller enables a defined actuation profile to be programmed into said servo system.

20. A medicament dispenser according to either of claims 18 or 19, wherein said feedback device provides an error signal in response to a deviation from the said programmed actuation profile.

21. A medicament dispenser according to any of claims 1 to 20, wherein actuation of the drive means results directly in actuation of the dispensing mechanism.

22. A medicament dispenser according to any of claims 1 to 20, wherein actuation of the drive means results indirectly in actuation of the dispensing mechanism.

23. A medicament dispenser according to any of claims 15 to 22, wherein said ultrasonic motor provides rotational drive.

24. A medicament dispenser according to claim 23, wherein a cam gear or a jacking plate translates said rotational drive into linear movement to actuate the dispensing mechanism.

25. A medicament dispenser according to any of claims 1 to 24, wherein the gear means has a gear ratio of from 20:1 to 1000:1.

26. A medicament dispenser according to claim 25, wherein the gear means has a gear ratio of from 100:1 to 200:1.

27. A medicament dispenser according to either of claims 25 or 26, wherein the gear means is selected from the group consisting of a cam gear, a screw drive, a lever, a crank shaft, a pulley and a hydraulic gear.

28. A medicament dispenser according to any of claims 1 to 27, additionally comprising locator means to locate the position, velocity, torque and/or acceleration of the medicament container therein.

29. A medicament dispenser according to claim 28, wherein said locator means acts such as to continually track the position of the medicament container within the medicament dispenser.

30. A medicament dispenser according to any of claims 1 to 29, additionally comprising zeroing means to position the medicament container at a defined zero position within the medicament dispenser.

31. A medicament dispenser according to any of claims 18 to 30, wherein the controller corrects for errors in the position, velocity, torque or acceleration profile of the drive means.

32. A medicament dispenser according to any of claims 1 to 31, wherein the drive means is actuable in response to electrical current flow in the range from 0.01 A to 100 A, preferably from 0.1 A to 5 A.

33. A medicament dispenser according to any of claims 1 to 32, additionally comprising an electrical energy source.

34. A medicament dispenser according to claim 33, wherein said electrical energy source comprises a voltaic cell or battery of voltaic cells.

35. A medicament dispenser according to claim 34, wherein said voltaic cell or battery of voltaic cells is rechargeable.

36. A medicament dispenser according to claim 33, wherein said electrical energy source comprises a photovoltaic cell or battery of photovoltaic cells.

37. A medicament dispenser according to claim 33, wherein said electrical energy source comprises a converter for converting mechanical energy into electrical energy.

38. A medicament dispenser according to any of claims 33 to 37, additionally comprising a regulator for controlling the amount of electrical current flow to the drive means.

39. A medicament dispenser according to claim 38, wherein said regulator comprises a timer for controlling the duration of electrical current flow to the drive means.

40. A medicament dispenser according to either of claims 38 or 39, wherein the regulator is responsive to one or more sensors.

41. A medicament dispenser according to claim 40, wherein said sensor senses position, velocity, torque, acceleration, movement, pressure and/or force characteristics.

42. A medicament dispenser according to either of claims 40 or 41, wherein the sensor monitors the electrical current flow to the drive means.

43. A medicament dispenser according to any of claims 32 to 42 additionally comprising a local electrical energy store.

44. A medicament dispenser according to any of claims 1 to 43, wherein said medicament container is a medicament aerosol container.

45. A medicament dispenser according to claim 44, wherein said medicament aerosol container comprises a suspension of a medicament in a propellant.

46. A medicament dispenser according to claim 45, wherein, said propellant comprises liquefied HFA134a, HFA-227, helium or carbon dioxide.

47. A medicament dispenser according to claim 46, wherein said medicament aerosol container comprises a solution of a medicament in a solvent.

48. A medicament dispenser according to any of claims 44 to 47, wherein said aerosol container comprises a compressed air or gas and the medicament container comprises medicament in dry powder form.

49. A medicament dispenser according to any of claims 45 to 48, wherein the medicament is selected from the group consisting of albuterol, salmeterol, fluticasone propionate, beclomethasone dipropionate, ipratropium salts or solvates thereof and any mixtures thereof.

50. A medicament dispenser according to any of claims 5 to 49, wherein the valve is a slide valve.

51. A medicament dispenser according to any of claims 5 to 49, wherein the valve is a metering valve.

52. A medicament dispenser according to any of claims 1 to 51, wherein the container seat is shaped for snug receipt of the base of the medicament container or aerosol container.

53. A medicament dispenser according to claim 2 or any of claims 4 to 52, wherein the dispenser seat is shaped for snug receipt of the tip of the dispensing mechanism.

54. A medicament dispenser according to claim 53, wherein the dispenser seat is further shaped to support the walls of the medicament container or aerosol container.

55. A medicament dispenser according to claim 54, wherein the container seat and dispenser seat in combination form a cradle for the medicament container or aerosol container.

56. A medicament dispenser according to any of claims 10 to 55, wherein flow of electrical current to the drive means and hence, actuation of the dispensing mechanism is responsive to a patient-actuable trigger.

57. A medicament dispenser according to claim 56, wherein said trigger comprises a button, switch or lever arrangement.

58. A medicament dispenser according to any of claims 1 to 57, in the form of an inhaler for the delivery of inhalable medicament.

59. A medicament dispenser according to claim 58, wherein flow of electrical current to the drive means and hence, actuation of the dispensing mechanism is responsive to a patient-actuable trigger comprising a sensor which senses the breath of a patient.

60. A medicament dispenser according to claim 59, wherein said sensor comprises a breath-movable element which is movable in response to the breath of a patient.

61. A medicament dispenser according to claim 60, wherein said breath-movable element is selected from the group consisting of a vane, a sail, a piston, a diaphragm and an impeller.

62. A medicament dispenser according to claim 59, wherein said sensor comprises a pressure sensor for sensing the pressure profile associated with the breath of a patient.

63. A medicament dispenser according to claim 59, wherein said sensor comprises an airflow sensor for sensing the airflow profile associated with the breath of a patient.

64. A medicament dispenser according to claim 59, wherein said sensor comprises a temperature sensor for sensing the temperature profile associated with the breath of a patient.

65. A medicament dispenser according to claim 59, wherein said sensor comprises a moisture sensor for sensing the moisture profile associated with the breath of a patient.

66. A medicament dispenser according to claim 59, wherein said sensor comprises a gas sensor for sensing the oxygen or carbon dioxide profile associated with the breath of a patient.

67. A medicament dispenser according to any of claims 1 to 66 comprising an actuation counter for counting the number of actuations of the dispensing mechanism or a dose counter for counting the number of doses delivered.

68. A medicament dispenser according to claim 67, wherein said actuation counter is independent of the drive means.

69. A medicament dispenser according to any of claims 1 to 68, comprising a manual override enabling manual actuation of the dispensing mechanism.

70. A medicament dispenser according to any of claims 1 to 69 additionally comprising an electronic control system for controlling the supply of non-mechanical energy to the drive means.

71. A medicament dispenser according to claim 70, wherein the electronic control system is capable of providing pulses of non-mechanical energy to the drive means.

72. A medicament dispenser according to either of claims 70 or 71, wherein the electronic control system is capable of receiving inputs from electronic sensors locatable on the dispenser.

73. A medicament dispenser according to claim 72, additionally comprising an electronic sensor selected from the group consisting of a breath sensor, a shake sensor, a temperature sensor, an infrared sensor and a patient ID sensor.

74. An actuator for a medicament container having a dispensing mechanism comprising
a container seat for receipt of the medicament container;
a dispenser seat for receipt of the dispensing mechanism; and
drive means capable of moving the container seat relative to the dispenser seat to actuate the dispensing mechanism, the drive means being actuable in response to the application of non-mechanical energy thereto,
wherein gear means are provided to said drive means to gear up the torque provided thereby.

75. An actuator for a medicament container having a dispensing mechanism comprising
a housing;
within said housing, a container seat for receipt of the medicament container;
on the housing or connecting therewith, an anchor station; and
drive means capable of moving the container seat relative to the anchor station to actuate the dispensing mechanism, the drive means being actuable in response to the application of non-mechanical energy thereto,
wherein gear means are provided to said drive means to gear up the torque provided thereby.

76. An actuator for a medicament dispenser having a medicament container and separately an aerosol container having a dispensing mechanism comprising
a housing, shaped for receipt of said medicament container for containing medicament for release;
within said housing, a container seat for receipt of said aerosol container having a dispensing mechanism;
an anchor station on the housing or connecting therewith; and
drive means capable of moving the container seat relative to the anchor station to actuate the dispensing mechanism to energise released medicament, the drive means being actuable in response to the application of non-mechanical energy thereto,
wherein gear means are provided to said drive means to gear up the torque provided thereby.

77. An actuator for a medicament dispenser having a medicament container and separately an aerosol container having a dispensing mechanism comprising
a housing, shaped for receipt of said medicament container for containing medicament for release;
an aerosol container having a dispensing mechanism;
a container seat for receipt of said aerosol container having a dispensing mechanism;
a dispenser seat for receipt of the dispensing mechanism; and
drive means capable of moving the container seat relative to the dispenser seat to actuate the dispensing mechanism to energise released medicament, the drive means being actuable in response to the application of non-mechanical energy thereto,
wherein gear means are provided to said drive means to gear up the torque provided thereby.

78. An actuator according to any of claims 74 to 77 additionally comprising an electronic control system for controlling the supply of non-mechanical energy to the drive means.

79. An actuator according to claim 78, wherein said electronic control system is capable of providing pulses of non-mechanical energy to the drive means.

80. An actuator according to either of claims 78 or 79, wherein the electronic control system is capable of receiving inputs from electronic sensors locatable on the dispenser.

81. An actuator according to claim 80, additionally comprising an electronic sensor selected from the group consisting of a breath sensor, a shake sensor, a temperature sensor, an infrared sensor and a patient ID sensor.

82. Laboratory test apparatus for testing a medicament container having a dispensing mechanism comprising at least one actuator according to any of claims 74 to 81 and a mounting for said at least one actuator.

83. Kit of parts comprising
a medicament dispenser according to any of claims 1 to 73 in the form of a cartridge; and
a housing shaped for receipt of said cartridge.
